(19) United States
(12) Patent Application Publication
(10) Pub. No.: US 2016/0147936 A1
(43) Pub. Date: May 26, 2016

(54) RATIONAL METHOD FOR SOLUBILISING PROTEINS

(71) Applicant: CAMBRIDGE ENTERPRISE LIMITED, Cambridge, Cambridgeshire (GB)

(72) Inventors: Michele VENDRUSCOLO, Cambridge, Cambridgeshire (GB); Pietro SORMANNI, Cambridge, Cambridgeshire (GB); Francesco APRILE, Cambridge, Cambridgeshire (GB)

(21) Appl. No.: 14/899,281

(22) PCT Filed: Jun. 17, 2014
(86) PCT No.: PCT/GB2014/051866

§ 371 Date: Dec. 17, 2015

(30) Foreign Application Priority Data
Jun. 18, 2013 (GB) 1310859.2

(51) Int. Cl. G06F 19/22; G06F 19/16; G06F 19/24

(52) U.S. Cl. CPC G06F 19/22; G06F 19/24; G06F 19/16

(57) ABSTRACT

A method and data processing system for identifying mutations or insertions that alter a property such as the solubility or aggregation propensity of an input polypeptide chain. The method comprises inputting a sequence of amino acids and a structure for said sequence for said target polypeptide chain; calculating a structurally corrected solubility or aggregation propensity profile for said target polypeptide chain; selecting, using said calculated profile, regions within said target polypeptide chain; identifying at least one position within each selected region suitable for mutations or insertions; generating a plurality of mutated sequences by mutations or insertions at least one identified position; and predicting a value of the solubility or aggregation propensity for each of the plurality of mutated sequences whereby any alteration to the solubility or aggregation propensity of the input polypeptide chain is identified. Predicting a value for solubility or aggregation propensity comprises: inputting each of the plurality of mutated sequences as an input polypeptide chain into a data processing system comprising a first trained neural network having a first function mapping an input to a first output value and a second trained neural network having a second function mapping an input to a second output value; generating a first output value of said solubility or aggregation propensity for each said input polypeptide chain using said first trained neural network; generating a second output value of said solubility or aggregation propensity for each said input polypeptide chain using said second trained neural network; and combining the first and second output values to determine a combined output value for the solubility or aggregation propensity.

### FIELD OF THE INVENTION

The present invention relates to a method for predicting the solubility of polypeptide chains, including antibodies. Other aspects of the invention relate to a method of making polypeptide chains with a reduced propensity to aggregate or enhanced solubility, and to a method of making a pharmaceutical composition comprising polypeptide chains with altered solubility.

### BACKGROUND TO THE INVENTION

Therapeutic proteins such as antibodies are widely employed for diagnostics and therapeutic purposes because of their capacity to bind to target molecules with high affinity and specificity. In antibodies, the residues responsible for antigen binding are found in the so-called complementarity-determining regions (CDRs). These solvent-exposed regions are known to contain, in many cases, some hydrophobic, poorly-soluble, aggregation-promoting residues that, in addition to helping antigen binding, can also mediate self-association and aggregation. For therapeutic applications, the poor solubility of proteins can prove especially problematic as aggregation may not only affects the activity and efficiency of the therapeutic, but also elicit an immune response (as described in “Aggregation-resistant domain antibodies engineered with changed mutations near the edges of the complementary determining regions” by Perchiacca et al, Prot Eng Des Sel 25, 591-601 2012). This problem is further exasperated by the need to formulate and store therapeutic proteins at high concentrations for efficient sub-cutaneous delivery. In contrast, as a rule, proteins are highly soluble at the concentration they are produced by healthy living organisms. Moreover, if we exclude the CDR regions in antibodies, which are unstructured but very small compared to the size of the whole antibody, these molecules are structured proteins, quite stable under physiological or close to physiological conditions.

Protein aggregation also represents a problem in vivo. A number of pathological conditions are associated with aberrant protein deposition or aggregation. Examples of such disorders include neurodegenerative conditions such as Alzheimer's, Huntington's and Parkinson's diseases.

Conversely, there are instances where it may be desirable to form aggregates, in particularly amyloid fibrils, such as for use as plastics materials in electronics, as conductors, for catalysis or as a slow release form of the polypeptide, or where polypeptide fibrils are to be spun into a polypeptide ‘yarn’ for various applications; for example as described in published patent applications WO0017328 (Dobson) and WO024321 (Dobson & McPhee).

It would therefore be useful to be able to predict the solubility of a target polypeptide chain and further predict what mutations or insertions could be made to the amino acid sequence to affect—preferably increase—its solubility while maintaining its structure and function.

Currently a number of computational methods are available to predict protein solubility or aggregation, mainly based on the sequence of the protein and physico-chemical properties such as hydrophobicity, charge and secondary structure propensities (“Rationalization of the effects of mutations on peptide and protein aggregation rates” by Chiti et al. Nature 424, 805-808 (2003)). Other methods based on the protein sequence include SOLpro (“SOLpro: Accurate sequence-based prediction of protein solubility” by Magnan et al., Bioinformatics 25, 2200-2207 (2009)) and PROSO II (“PROSO II—a new method for protein solubility prediction” by Smialowski et al, FEBS J 279, 2192-2200 (2012)).

When predicting protein solubility for medical applications, however, it is very important to remember that these proteins are already folded inside the expression organism before they are concentrated. Aggregation is consequently initiated from the native state of the protein. Thus, the aggregation pathway is mediated by partial unfolding events leading to the formation of oligomeric species, which, in some cases can evolve into fibrillar conformations once a critical number of molecules is present, so that the enthalpy associated with their ordered stacking overcomes the corresponding loss of conformational entropy.

For this reason there is a need to calculate the structurally-corrected solubility or aggregation propensities, which correspond to the propensity to remain soluble or aggregate of a protein in its native state. Such structurally-corrected solubility or aggregation propensities can be very different from the corresponding intrinsic propensities, which refer to the propensities of solubility or aggregation of the unfolded state. In fact, ordered proteins tend to bury their poorly-soluble, aggregation promoting regions inside the native structure. There are cases, however, and antibodies are one example, where some of these aggregation-prone residues need to be exposed on the surface for structural or functional reasons (“Physico-chemical principles that regulate the competition between functional and dysfunctional association of proteins”. Pechmann et al. Proc. Natl. Acad. Sci. USA, 106, 10159-10164 (2009)). For some antibodies, exposing ‘sticky’ (i.e. aggregation-prone) residues in their CDR loops is essential for antigen binding.

Here we present a computational algorithm that can predict the solubility of a target polypeptide chain in its native conformation, and furthermore can be used to predict specific amino acid substitutions and/or insertions that will alter the solubility of a target polypeptide chain while preserving its structure and functionality. The algorithm is very general and can be readily applied to any peptide or protein, requiring only knowledge of the protein sequence, structure and the residues that are important for function.

Furthermore, in cases where homology modeling can be applied, the knowledge of the structure is not necessary. Thus, the algorithm presented here allows for the rational design and production of a target polypeptide chain with a desired solubility, which is related to, but distinct from, the aggregation propensity (see FIG. 1d). The production of such proteins is highly desirable, with applications ranging from industry to research and various medical treatments.

### SUMMARY OF THE INVENTION

According to a first aspect of the invention, there is provided a method of identifying mutations or insertions that alter a property such as the solubility or aggregation propensity of an input polypeptide chain as set out in claim 1. According to another aspect of the invention, there is provided a data processing system for identifying mutations or insertions that alter the solubility or aggregation propensity of an input polypeptide chain as set out in claim 29.

In both aspects, the data processing system may be trained by training said first neural network in said data processing system using a set of polypeptide chains having known sequences of amino acids and known values for the solubility or aggregation propensity to determine a first function which maps the known sequences to the known values. Said training may comprise dividing each polypeptide chain in said set of polypeptide chains into a plurality of segments, with each segment having a first fixed length; inputting each segment into said first neural network by representing each amino acid in each segment using an input neuron in the first neural network; and
determining said first function from said input segments and said known values. Said second neural network in said data processing system may be trained using said set of polypeptide chains to determine a second function which maps the known sequences to the known values. Said training may comprise dividing each polypeptide chain in said set of polypeptide chains into a plurality of segments each having a second fixed length; wherein said second length is greater than said first length; inputting each segment into said second neural network by representing each amino acid in each segment using an input neuron in the second neural network; and
determining said second function from said input segments and said known values. It will be appreciated that the training of the first and second neural networks may be carried out as a separate and discrete process.

Thus, according to another aspect of the invention, there is provided a method of training a data processing system to predict a value for a property of a first polypeptide chain comprising a sequence of amino acids, the method comprising:
training a first neural network in said data processing system using a set of polypeptide chains having known sequences of amino acids and known values for said property to determine a first function which maps the known sequences to the known values, wherein said training comprises
dividing each polypeptide chain in said net of polypeptide chains into a plurality of segments each segment having a first fixed length;
inputting each segment into said first neural network by representing each amino acid in each segment using an input neuron in the first neural network; and
determining said first function from said input segments and said known values;
training a second neural network in said data processing system using said set of polypeptide chains to determine a second function which maps the known sequences to the known values, wherein said training comprises
dividing each polypeptide chain in said set of polypeptide chains into a plurality of segments each having a second fixed length; wherein said second length is greater than said first length;
inputting each segment into said second neural network by representing each amino acid in each segment using an input neuron in the second neural network; and
determining said second function from said input segments and said known values.

According to another aspect of the invention, there is provided a data processing system which has been trained to predict a value for a property of a polypeptide chain comprising a sequence of amino acids, the system comprising:
a first neural network trained using a set of polypeptide chains having known sequences of amino acids and known values for said property to determine a first function which maps the known sequences to the known values, wherein said second neural network is trained by
dividing each polypeptide chain in said net of polypeptide chains into a plurality of segments, with each segment having a first fixed length;
inputting each segment into said first neural network by representing each amino acid in each segment using an input neuron in the first neural network; and
determining said first function from said input segments and said known values;
a second neural network trained using said set of polypeptide chains to determine a second function which maps the known sequences to the known values, wherein said second neural network is trained by
dividing each polypeptide chain in said set of polypeptide chains into a plurality of segments each having a second fixed length; wherein said second length is greater than said first length;
inputting each segment into said second neural network by representing each amino acid in each segment using an input neuron in the second neural network; and
determining said second function from said input segments and said known values.

The following features apply to the methods and systems described above.

The first and second neural networks may be trained simultaneously so that the networks are available for prediction at a similar level of accuracy after a similar time scale. It will be appreciated that it may take longer to train the second network because longer segments are used. It will also be appreciated that more neural networks with different lengths of segments may also be used.

The neural network may be a deterministic neural network for example, a non-linear multilayer perceptron. Here, by non-linear, it is meant that one or more layers of neurons in the network have a non-linear transfer function so that the network is not constrained to fit just linear data. The skilled person will recognise that, in principle, the mapping need not be performed by a neural network but may be performed by any deterministic function, for example a large polynomial, splines or the like, but in practice such techniques are undesirable because of the exponential growth in the number of parameters needed as the length of the input/output vectors increases.

The known value may be a solubility or aggregation propensity value, for example a profile having a solubility or aggregation value for each amino acid in the sequence. The method may also be used for other known values, for example a profile having a solubility or aggregation value for each amino acid in the sequence, or solvent exposure, secondary structure population or any other property that can be expressed as one value per residue in the sequence. Where the known value is in the form of a profile, i.e. a set of M real numbers (x₀, x₁, . . . , x_{M-1}), the method may comprise applying a Fourier transform to the profile to determine a net of Fourier coefficients. For example, the discrete Fourier Transform (DFT) may be used where:

$${X}_{k} = {\sum }_{n = 0}^{M - 1} {x}_{n} \cdot {e}^{- i 2 π \frac{k}{M} n}$$

A subset of the net of Fourier coefficients may be used as the known values. In this way, a smaller number of output neurons is required. Moreover, by training the networks to predict only half of the coefficients, the improvement in the accuracy of the neural network appears to have compensated the error introduced by reconstructing the profile from only half of the coefficients.

Once trained, the data processing system may be used to predict values, for example solubility or aggregation values if this is what it was trained on. Thus, generating said first output value of said solubility or aggregation propensity for each said input polypeptide chain using said first trained neural network may comprise dividing each said input polypeptide into a plurality of segments each having a first fixed length, inputting each amino acid in each segment to the first neural network; using the first function to map the input amino acids to a first segment output value for each segment; and combining the first segment output values to generate said first output value. Similarly, generating a second output value of said solubility or aggregation propensity for each said input polypeptide chain using said second trained neural network comprises dividing said input polypeptide chain into a plurality of segments each having a said second length which is greater than said first length, inputting each amino acid in each segment to the second neural network and using the second function to map the input amino acids to a second segment output value for each segment; and combining the second segment output values to generate said second output value. It will be also appreciated that the prediction process may be a stand-alone process.

Thus, according to another aspect of the invention, there is provided a method of predicting a value for a property of an input polypeptide chain comprising a sequence of amino acids, the method using a data processing system comprising a first trained neural network having a first function mapping an input to a first output value and a second trained neural network having a second function mapping an input to a second output value, the method comprising:
generating a first output value of said property for said input polypeptide chain using said first trained neural network by
dividing said input polypeptide chain into a plurality of segments each having a first fixed length,
inputting each amino acid in each segment to the first neural network;
using the first function to map the input amino acids to a first segment output value for each segment; and
combining the first segment output values to generate said first output value:
generating a second output value of said property for said input polypeptide chain using said second trained neural network by
dividing said input polypeptide chain into a plurality of segments each having a said second length which is greater than said first length,
inputting each amino acid in each segment to the second neural network and
using the second function to map the input amino acids to a second segment output value for each segment; and
combining the second segment output values to generate said second output value; and
combining the first and second output values to determine a combined output value for the property.

According to another aspect there is provided a data processing system for predicting a value for a property of an input polypeptide chain comprising a sequence of amino acids, the data processing system comprising
a first trained neural network having a first function mapping an input to a first output value;
a second trained neural network having a second function mapping an input to a second output value; and
a processor which receives data from the first and second trained neural networks,
wherein said first trained neural network is configured to generate a first output value of said property for said input polypeptide chain by
   dividing said input polypeptide into a plurality of segments each having a first fixed length,
   inputting each amino acid in each segment to the first neural network;
   using the first function to map the input amino acids to a first segment output value for each segment; and
   combining the first segment output values to generate said first output value;
wherein said second trained neural network is configured to generate a second output value of said property for said input polypeptide chain by
   dividing said input polypeptide chain into a plurality of segments each having a said second length which is greater than said first length,
   inputting each amino acid in each segment to the second neural network and
   using the second function to map the input amino acids to a second segment output value for each segment; and
   combining the second segment output values to generate said second output value; and
wherein the processor is configured to combine the first and second output values to determine a combined output value for the property.

Again the following features apply to the methods and systems described above.

If more than two networks are used, the processor may be configured to combine all output values to determine the combined output value. The data processing system and thus the first and second neural networks may be trained as described above. Thus, the value to be predicted may be a solubility value or an aggregation propensity value, e.g. a profile having a value for each amino acid in the sequence.

Where the networks were trained to predict Fourier coefficients as described above, the first and second segment output values may be a set of Fourier coefficients. The Fourier coefficients may then be converted to the full profile by applying an inverse Fourier transform. For the DFT above, the reverse transform may take the form:

$${x}_{n} = \frac{1}{M} {\sum }_{k = 0}^{M - 1} {X}_{k} \cdot {e}^{- i 2 π \frac{k}{M} n}$$

The Fourier coefficients represent the oscillatory modes of the profile. Accordingly, the first network that covers a sequence segment of smaller length k (suppose k<l) is better suited to capture high frequency modes, while the second network captures low frequency modes. Therefore the employment of two networks increases the accuracy of the reconstruction from the Fourier coefficients.

The Fourier method may thus be used with only one network, thus, according to another aspect of the invention, there is provided a method of training a data processing system to predict a value for a property of a first polypeptide chain comprising a sequence of amino acids, the method comprising training a neural network in said data processing system using a set of polypeptide chains having known sequences of amino acids and known values for said property, the known values being in the form of profiles having a value for each amino acid, wherein said training comprises dividing each polypeptide chain in said set of polypeptide chains into a plurality of segments each segment having a first fixed length and an associated section of the profile; applying a Fourier transform to each associated section of the profile to generate a set of Fourier coefficients for each segment; inputting each segment into said first neural network by representing each amino acid in each segment using an input neuron in the first neural network and representing; and determining a function which maps the input segments and to the set of Fourier coefficients for each segment.

When the sequence is divided into a plurality of segments potential problems could arise at the boundaries of the segments because the influence of neighbouring residues belonging to different segments would be neglected. The use of two networks of different length helps to solve the fixed length problem provided the second length is not a multiple of the first length. The first length may for example be 22 and the second length may for example be 40. The number of input neurons in each network matches the length of the fragments. Thus, the first neural network may have 22 input neurons in an input layer and the second neural network may have 40 input neurons.

Another way to solve this problem comprises dividing the polypeptide chain into a plurality of segments each having an overlapping region with adjacent segments. The overlapping region may comprise at least one amino acid, perhaps two to four amino acids, which is present in both adjacent segments. Splitting the sequence into segments having a longer length may mean that the overlapping regions may also be longer, e.g. to ensure that the segments have uniform length. The overlapping region may have a length which ranges from one amino acid through to all amino acids except one. Thus for a polypeptide chain of length n, the overlapping region may have a length of between 1 and n−1. For each network having an overlapping region of n−1 residues, the network resembles a sliding window that moves one residue at a time along the sequence, an approach that can be preferable for some applications.

The prediction method above can be used to identify mutations or insertions that alter the aggregation properties and hence the solubility of a target (or input) polypeptide chain. For example, according to another aspect of the invention, there is provided a method of identifying poorly soluble aggregation-prone regions in a target polypeptide chain, the method comprising predicting a value for solubility or aggregation propensity using the method described above, comparing the predicted values against a threshold value and identify the poorly soluble or aggregation-prone regions as regions having predicted values above the threshold value. In a preferred embodiment, the polypeptide chain is in its native (i.e. folded) state.

According to another aspect of the invention, there is provided a method of identifying mutations or insertions that alter the solubility or aggregation propensity of an input polypeptide chain, the method comprising
inputting a sequence of amino acids and a structure for said sequence for said target polypeptide chain;
calculating a structurally-corrected aggregation propensity profile for said target polypeptide chain;
selecting, using said calculated profile, regions within said target polypeptide chain;
identifying at least one position within each selected region which is suitable for mutation or insertion;
generating a plurality of mutated sequences by mutating or inserting at least one identified position; and
predicting a value for aggregation propensity for each of the plurality of mutated sequences whereby any alteration to the aggregation propensity of the input polypeptide chain is identified.

The methods described above may be used to identify mutations which increase or decrease the solubility of the target polypeptide chain. Alternatively, the methods may be used to alter the solubility of the target polypeptide chain to a desired amount.

The regions may be selected by comparing the score of each amino acid in the sequence to a threshold value, e.g. one, and selecting a region having more than a number of adjacent amino acids above the threshold value. These fragments correspond to the ‘dangerous’ regions, i.e. those that can reduce solubility or trigger aggregation. The selected regions may be ranked by taking into account both the length (the size of the ‘dangerous’ region) and its solubility or aggregation propensity (how dangerous its components are) but it will be appreciated that other ranking scores may be awarded. The ranking preferably sorts the regions from less soluble or more soluble, or from more aggregation-prone to less aggregation-prone.

The method of prediction using neural networks described above may be used to predict a value for solubility or aggregation propensity. This method is able to run much faster than other methods for calculating solubility or aggregation propensity such as the structurally-corrected value used in the calculating step. Although this predicted value is designed to depict the tendency to remain soluble or aggregate from the unfolded state, the positions selected for mutations were selected using the structurally-corrected value. As a result, the predicted effect of a mutation at one of these positions on the solubility should, to a very good approximation, be the same. However, as a check, the structurally-corrected values may also be calculated for some or all of the mutated sequences as explained in more detail below.

The structurally-corrected solubility or aggregation propensity profile comprises a score for each amino acid in the sequence. The structurally-corrected solubility or aggregation propensity score may be calculated in any known way but it is essential that the score takes account both of the intrinsic propensity to aggregate and the native structure of the sequence. One method for calculating the score is set out in more detail below, the structurally-corrected solubility or aggregation propensity score Aᵢ^{surf} of residue i can be written as a sum which is extended over all the residues of the protein within a distance r_{S} from residue i:

$${A}_{i}^{surf} = {\sum }_{j} {w}_{j}^{D} {w}_{j}^{E} {A}_{j}^{int}$$

$$or$$

$${A}_{i}^{surf} = {w}_{i}^{E} ( {A}_{i}^{int} + {\sum }_{j \neq 1} {w}_{j}^{D} {w}_{j}^{E} {A}_{j}^{int} )$$

where wⱼ^{E} is the “exposure weight” which depends on the solvent exposure of residue j, and wⱼ^{D} is the “smoothing weight”, defined as

$${w}_{j}^{D} = max ( 1 - \frac{{d}_{ij}}{{r}_{s}} , 0 )$$

where dᵢⱼ is the distance of residue j from residue i.

The exposure weight is defined as

$${w}_{j}^{E} = \frac{ϑ ( {x}_{j} - 0.05 )}{1 + {e}^{- a ( {x}_{j} - b )}}$$

where xⱼ is the relative exposure of residue j, i.e. the SASA (solvent accessible surface area) of residue j in the given structure divided by the SASA of same residue in isolation, and θ is the Heaviside step-function, which is employed so that residues less than 5% solvent-exposed are not taken into account.

The identified positions may be ranked, for example, using a combination of the ranking applied to each sequence and its individual score. Again, the ranking may be from less soluble or more soluble, or from more aggregation-prone to less aggregation-prone.

We now have a list of positions that are suitable for mutations and/or insertions. These positions are mapped on both the sequence and the structure. On one hand it could be desirable to perform mutations/insertions at several positions, in order to maximise the solubility of the resulting protein. On the other, too many mutations could change the protein too much.

Rather than constraining the number of mutations/insertions to perform, one might wish to stop doing mutations when a given solubility is reached. Accordingly, the method may comprise choosing the top ranked position and generating the plurality of mutated sequences by applying a plurality of mutations and/or insertions at that position. The aggregation propensity is then predicted for each of these mutated sequences and optionally ranked. We then determine whether any of the predicted values for solubility or aggregation propensity is higher than a threshold value (i.e. the value corresponding to the desired result), in particular the predicted value for the top ranked sequence and when the predicted value is higher than the threshold value, output the mutated sequence as a target polypeptide. When the predicted value is lower than the threshold value, the method reiterates. Thus the choosing, generating and determining steps may be repeated for the next ranked position until the predicted value is higher than the threshold value.

Alternatively, a user may input that at most N mutations (preferably 3 or 4 mutations) may be performed. Accordingly, the method may comprise choosing a set of the top N ranked positions and generating the plurality of mutated sequences by applying at least some of all possible mutations and insertions at that net of positions. The number of mutations/insertions can be decreased, for example by excluding from the list of candidates the strongly hydrophobic amino acids (i.e. tryptophan, threonine, valine, leucine, isoleucine, phenylalanine residues) because it is known that their effect, if any, is to increase the aggregation propensity. The predicted value for solubility or aggregation propensity for each mutated sequence may then be ranked and the highest ranked mutated sequences may be output with their values as the output polypeptides. The structurally-corrected aggregation propensity which was calculated for the original sequence may also be calculated for each of these top-ranked mutated sequences and the ranking may be reorganised based on the structurally-corrected solubility or aggregation propensity.

Another input to the system is preferably to indicate any positions at which mutations or insertions are prohibited. Accordingly, the method may further comprise identifying any positions at which mutations or insertions are prohibited and flagging such positions as immutable so that in the generating steps no mutations or insertions are applied at these positions. If all the positions in a selected region are flagged as immutable, the positions at the side of the selected region may be identified as positions which are suitable for mutation or insertion.

The methods of predicting and training may preferably be computer-implemented methods. The invention thus further provides processor control code to implement the above-described systems and methods, for example on a general-purpose computer system or on a digital signal processor (DSP). The code is provided on a physical data carrier such as a disk. CD- or DVD-ROM, programmed memory such as non-volatile memory (eg Flash) or read-only memory (Firmware). Code (and/or data) to implement embodiments of the invention may comprise source, object or executable code in a conventional programming language (interpreted or compiled) such as C. Python, or assembly code. As the skilled person will appreciate such code and/or data may be distributed between a plurality of coupled components in communication with one another.

In another aspect the invention provides a method of making a target polypeptide with altered solubility or aggregation propensity comprising identifying a mutation and/or insertion that alters the solubility of the target polypeptide as defined above and making a polypeptide chain comprising said mutation(s) and/or insertion(s). In a preferred embodiment, the method is a method of making a protein with increased solubility or a reduced propensity to aggregate. In an alternative embodiment, the method is a method of making a protein with decreased solubility or an enhanced propensity to aggregate. The protein can be made using techniques well known in the art. Such techniques include chemical synthesis using for example, solid-phase synthesis or using standard recombinant techniques.

The ability of a polypeptide chain to form highly-organised aggregates such as amyloid fibrils has been found to be a generic property of polypeptide chains regardless of their structures or sequences, and not simply a feature of a small number of peptides and proteins associated with recognised pathological conditions (C. M. Dobson, “The structural basis of protein folding and its links with human disease,” Philos. Trans. R. Soc. Lond., B. Sci., vol. 356, no. 1406, pp. 133-145. February 2001). For this reason the target polypeptide chain can be any sequence of at least two amino acids (also called residues) joined by a peptide bond, regardless of length, post-translational modification, chemical modification or function. Similarly, the polypeptide chain may be naturally occurring or chemically synthesized, wild type or recombinant, such as a chimeric or hybrid. In the present invention the terms ‘polypeptide chain’, ‘peptide’ and ‘protein’ are used interchangeably.

In one aspect, the target polypeptide chain may be any protein, including but not limited to a protein hormone, antigen, immunoglobulin (e.g. antibody), repressors/activators, enzymes, cytokines, chemokines, myokines, lipokines, growth factors, receptors, receptor domains, neurotransmitters, neurotrophins, interleukins, interferons and nutrient-transport molecules (e.g. transferrin).

In a preferred embodiment, the target polypeptide chain is a CDR-containing polypeptide chain such as a T-cell receptor or antibody. In a preferred embodiment the CDR-containing polypeptide chain is an antibody or antigen-binding fragment thereof.

The term ‘antibody’ in the present invention refers to any immunoglobulin, preferably a full-length immunoglobulin. Preferably, the term covers monoclonal antibodies, polyclonal antibodies, multispecific antibodies, such as bispecific antibodies, and antibody fragments thereof, so long as they exhibit the desired biological activity. Antibodies may be derived from any species. Alternatively, the antibodies may be humanised, chimeric or antibody fragments thereof. The immunoglobulins can also be of any type (e.g. IgG, IgE, IgM, IgD, and IgA), class (e.g., IgGI, IgG2, IgG3, IgG4, IgAI and IgA2) or subclass of immunoglobulin molecule.

The term ‘antigen-binding fragment’ in the present invention refers to a portion of a full-length antibody where such antigen-binding fragments of antibodies retain the antigen-binding function of a corresponding full-length antibody. The antigen-binding fragment may comprise a portion of a variable region of an antibody, said portion comprising at least one, two, preferably three CDRs selected from CDR1. CDR2 and CDR3. The antigen-binding fragment may also comprise a portion of an immunoglobulin light and heavy chain. Examples of antibody fragments include Fab, Fab′, F(ab′)2, scFv, di-scFv, and BiTE (Bi-specific T-cell engagers), Fv fragments including nanobodies, diabodies, diabody-Fc fusions, triabodies and, tetrabodies; minibodies; linear antibodies; fragments produced by a Fab expression library, anti-idiotypic (anti-Id) antibodies, CDR (complementary determining region), and epitope-binding fragments of any of the above that immunospecifically bind to a target antigen such as a cancer cell antigens, viral antigens or microbial antigens, single-chain or single-domain antibody molecules including heavy chain only antibodies, for example, camelid VHH domains and shark V-NAR; and multispecific antibodies formed from antibody fragments. For comparison, a full-length antibody, termed ‘antibody’ is one comprising a VL and VH domains, as well as complete light and heavy chain constant domains.

The term ‘antibody’ may also include a fusion protein of an antibody, or a functionally active fragment thereof, for example in which the antibody is fused via a covalent bond (e.g., a peptide bond), at either the N-terminus or the C-terminus to an amino acid sequence of another protein (or portion thereof, such as at least 10, 20 or 50 amino acid portion of the protein) that is not the antibody. The antibody or fragment thereof may be covalently linked to the other protein at the N-terminus of the constant domain.

Furthermore, the antibody or antigen-binding fragments of the present invention may include analogs and derivatives of antibodies or antigen-binding fragments thereof that are either modified, such as by the covalent attachment of any type of molecule as long as such covalent attachment permits the antibody to retain its antigen binding immunospecificity. Examples of modifications include glycosylation, acetylation, pegylation, phosphorylation, amidation, derivatization by known protecting/blocking groups, proteolytic cleavage, linkage to a cellular antibody unit or other protein, etc. Any of numerous chemical modifications can be carried out by known techniques, including, but not limited to specific chemical cleavage, acetylation, formylation, metabolic synthesis in the presence of tunicamycin, etc.

Additionally, the analog or derivative can contain one or more unnatural amino acids. When non-natural amino acids or post-translational modification come into play the method can be easily applied at a good level of approximation by replacing such amino acids with the natural ones (Modifications seldom take place close to aggregation promoting regions). To actually account for modifications rather than neglecting them one would need to introduce correction to the intrinsic profile.

In an alternative embodiment, the target polypeptide chain is a peptide hormone. Examples of peptide hormones include insulin, glucagon, islet amyloid polypeptide (IAPP), ACTH (corticotrophin), granulocyte colony stimulating factor (G-CSF), tissue plasminogen, somatostatin, erythropoietin and calcitonin.

In a further alternative embodiment, the target polypeptide may be a protein associated with an amyloid disease. Examples include, but are not limited to, the Aβ peptide (Alzheimer's disease), amylin (or IAPP) (Diabetes mellitus type 2), α-synuclein (Parkinson's disease), PrP^{Sc} (Transmissible spongiform encephalopathy), huntingtin (Huntington's disease), calcitonin (medullary carcinoma of the thyroid), atrial natriuretic factor (cardiac arrhythmias, isolated atrial amyloidosis), apoloprotein A1 (Atherosclerosis), seum amyloid A (Rheumatoid arthritis), medin (Aortic medial amyloid), prolactin (Prolactinomas), transthyretin (Familial amyloid polyneuropathy), lysozyme (Hereditary non-neuropathic systemic amyloidosis), β2 microglobulin (Dialysis related amyloidosis), gelsolin (Finnish amyloidosis), keratoepithelin (Lattice corneal dystrophy), crystatin (Cerebral amyloid angiopathy, Icelandic type), immunoglobulin light chain AL (Systemic AL amyloidsosis), fibrinogen Aα chain (Familial visceral amyloidosis), oncostatin M receptor (Primary cutaneous amyloidosis), integral membrane protein 2B (Cerebral amyloid angiopathy. British type) and S-IBM (Sporadic inclusion body myositis).

Further examples of the target polypeptide include angiogenin, anti-inflammatory peptides. BNP, endorphins, endothelin, GLIP, Growth Hormone Releasing Factor (GRF), hirudin, insulinotropin, neuropeptide Y, PTH, VIP, growth hormone release hormone (GHRH), octreotide, pituitary hormones (e.g., hGH), ANF, growth factors, bMSH, platelet-derived growth factor releasing factor, human chorionic gonadotropin, hirulog, interferon alpha, interferon beta, interferon gamma, interleukins, granulocyte macrophage colony stimulating factor (GM-CSF), granulocyte colony stimulating factor (G-CSF), menotropins (urofollitropin (FSH) and LH)), streptokinase, urokinase, ANF, ANP, ANP clearance inhibitors, antidiuretic hormone agonists, calcitonin gene related peptide (CGRP). IGF-I, pentigetide, protein C, protein S, thymosin alpha-1, vasopressin antagonist analogs, dominant negative TNF-α, alpha-MSH, VEGF, PYY, and polypeptide chains, fragments, polypeptide analogs and derivatives of the above.

In one aspect of the invention, there is provided a method of making a pharmaceutical composition wherein the composition comprises one or more polypeptide chains produced by the methods described herein formulated with a pharmaceutically acceptable carrier, adjuvant and/or excipient. In a preferred embodiment, the method is a method of making a pharmaceutical composition comprising a target polypeptide chain with an increased solubility or a reduced propensity to aggregate. In an alternative embodiment, the method is a method of making a pharmaceutical composition comprising a target polypeptide chain with a decreased solubility or an increased propensity to aggregate. Pharmaceutical compositions of the present invention can also be administered as part of a combination therapy, meaning the composition is administered with at least one other therapeutic agent, for example, an anti-cancer drug.

A pharmaceutically acceptable carrier can include solvents, dispersion media, coatings, antibacterial and antifungal agents, isotonic and absorption delaying agents. Preferably the carrier is suitable for intravenous, intramuscular, subcutaneous, parenteral, spinal or epidermal administration.

The pharmaceutical compositions of the present invention may also include one or more pharmaceutically acceptable salts, a pharmaceutically acceptable anti-oxidant, excipients and/or adjuvants such as wetting agents, emulsifying agents and dispersing agents.

In another aspect of the invention there is provided a polypeptide chain, preferably an antibody, with altered solubility or an aggregation propensity obtained or obtainable by the methods described herein. In a preferred embodiment, the polypeptide chain has a reduced propensity to aggregate or an increased solubility. In an alternative embodiment the polypeptide chain has an increased propensity to aggregate or a decreased solubility. In certain embodiments the polypeptide chain may be used as a medicament. In one embodiment the polypeptide chain may be used in the treatment of a disease, such as but not limited to, autoimmune diseases, immunological diseases, infectious diseases, inflammatory diseases, neurological diseases and oncological and neoplastic diseases including cancer.

### BRIEF DESCRIPTION OF THE DRAWINGS

The present invention will now be described, by way of example only, with reference to the accompanying drawings, in which:

FIGS. 1a to 1c show a flowchart for two implementations of the method;

FIG. 1d is a graph schematically illustrating the free energy landscape of protein aggregation;

FIG. 2a is a schematic representation of a feed-forward artificial neural network for use in the method of FIGS. 1a to 1c;

FIG. 2b is a schematic representation of an artificial neuron for use in the network of FIG. 2b;

FIG. 3a is a flowchart for the steps in training a neural network according to the present invention;

FIG. 3b is a flowchart for the steps in using the trained neural network of FIG. 3a to predict output values;

FIGS. 4a and 4b show how two different segment sizes are chosen for the schemes of FIGS. 3a and 3b;

FIG. 4c shows how training sets are created for the scheme of FIG. 3a;

FIG. 5 plots the original propensity profile superimposed on the propensity profile obtained with the inverse Fourier transform of only half of the coefficients.

FIG. 6a shows an averaged profile for a first plurality of segments;

FIG. 6b shows an averaged profile for a second plurality of segments;

FIG. 6c shows an averaged profile for the profiles of FIGS. 6a and 6b;

FIG. 7 shows the correlation between the calculated aggregation propensity and the experimentally determined critical concentration (micro Molar) for the test protein and its six variants; and

FIG. 8 is a schematic block diagram of a system for implementing the methods of FIGS. 1a to 7.

### DETAILED DESCRIPTION OF THE INVENTION

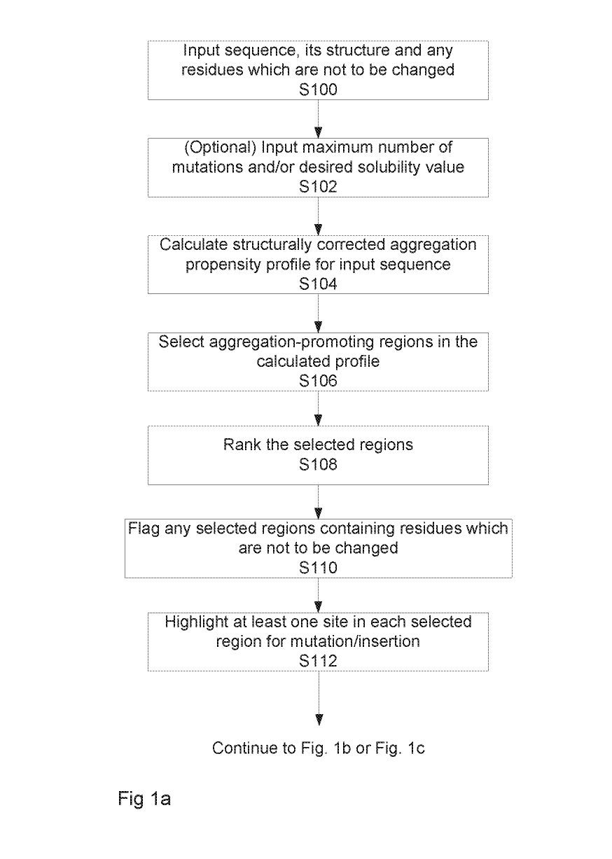

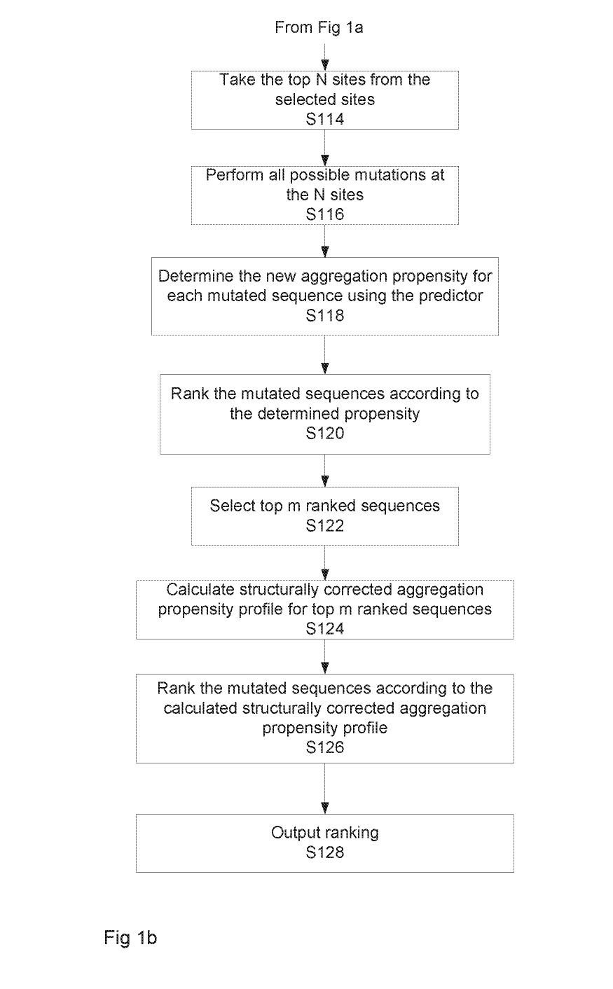

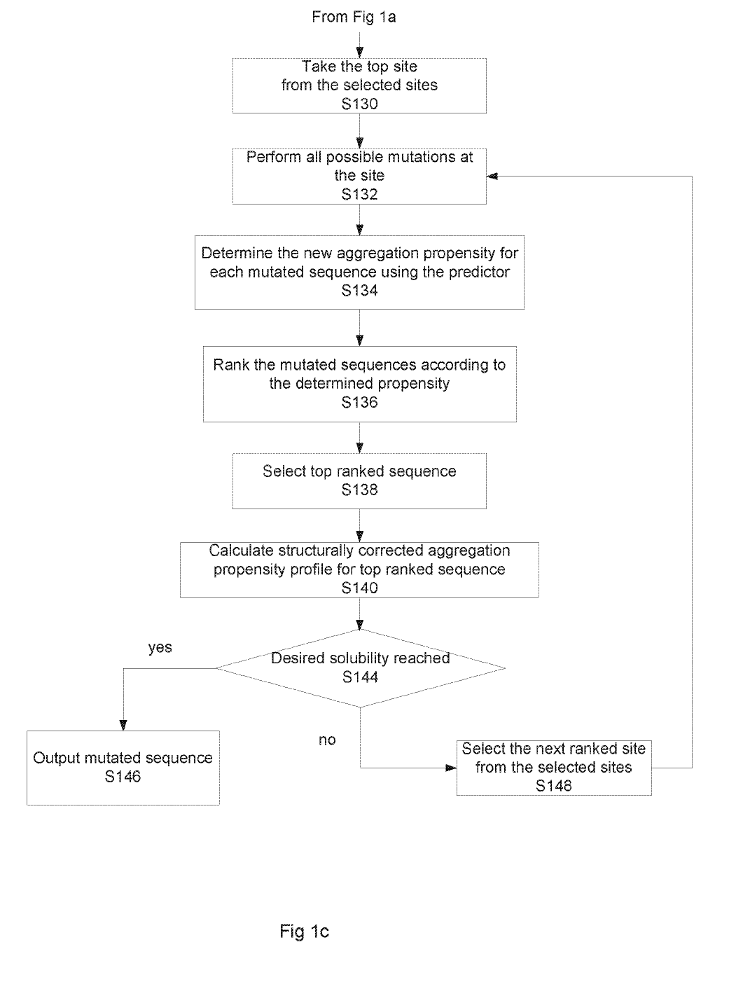

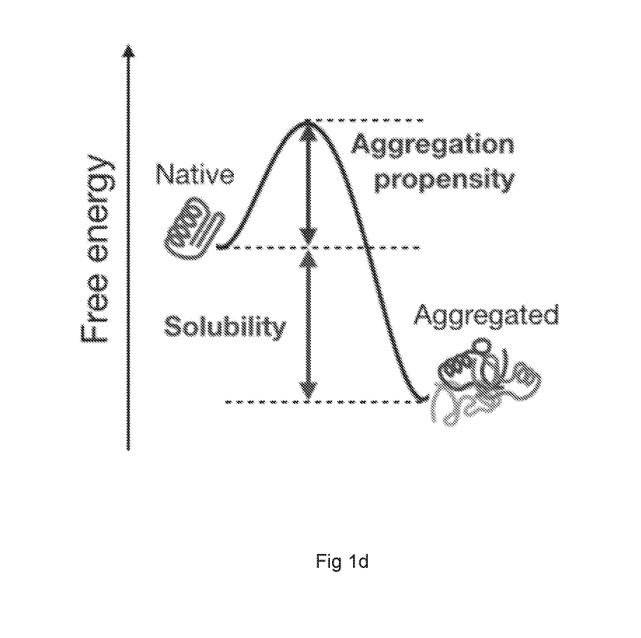

FIGS. 1a to 1c illustrate two alternative implementations of the method for determining a modified sequence having a desired output value, in this example a solubility value. As mentioned above, the algorithm allows for the rational design and production of a target polypeptide chain with a desired solubility, which is related to, but distinct from, the aggregation propensity. FIG. 1d schematically illustrates the relationship between solubility and aggregation propensity. It shows that the solubility of a protein depends on the free energy difference between the native and the aggregated states, while the aggregation rate depends on the free energy barrier between these two states. As explained in more detail below, the method calculates the aggregation propensity of the polypeptide chain, selects those residues which contribute more to the aggregation propensity and finally designs some mutations or insertion to increase the solubility.

Returning to FIG. 1a, as shown at step S100, the method preferably requires three inputs: an input sequence (to be modified), the structure of the input sequence and a list of residues within the input sequence that are important for functioning and hence cannot be mutated. At least in the case of antibodies, however, both the structure and the residues responsible for antigen binding are easily obtainable from the sequence. In fact antibodies share a high degree of sequence and structure similarity. Thus the structure can be obtained easily by computationally mapping the input sequence on one (or some) existing antibody structure. This procedure is called homology modeling, or comparative structure modeling, and there are plenty of standard techniques to perform it. For example A. Fiser and A. Sali, “Modeller: generation and refinement of homology-based protein structure models,” Meth. Enzymol., vol. 374, pp. 461-491, 2003 or The book Protein Structure Prediction: A Practical Approach: A Practical Approach edited by Michael J. E. Sternberg provides examples of homology modeling as well as description of techniques to predict CDR regions in antibodies. Similarly, the residues responsible for antigen binding can be obtained by aligning the input sequence to a library of sequences of antibodies. The only residues that will not show a high degree of conservation are those responsible for antigen binding, as they are antigen specific and consequently poorly conserved across different antibodies. This is again a standard technique.

An optional step S102 also includes inputting the maximum number N of mutations that are to be considered. A desired output value may also be input.

Once the various inputs are entered, at step S104, the structurally-corrected aggregation propensity is calculated for the whole sequence (i.e. for the whole molecule). This calculation yields a solubility score that is related to the solubility of the whole protein. This calculation also gives a profile, which is a score representative of the propensity for aggregation for every amino acid along the sequence.

The solubility score is calculated from the aggregation propensity profile, as predicted by the neural networks (intrinsic solubility score) or as modified by the structural correction (structurally-corrected solubility score, also called structurally-corrected aggregation propensity score). The solubility score takes into account only aggregation promoting residues (value in the profile larger than 1) and aggregation-resistant residues (value in the profile smaller than −1) and ignores all intermediate values, which are treated as neutral noise in the profile. Specifically, it is the sum of the individual aggregation propensity of those residues with aggregation propensity values either larger than one or smaller than minus one divided by the total length of the sequence.

As a consequence, a protein sequence with no solubility enhancing and no solubility reducing, or no aggregation-promoting and no aggregation-resistant regions will have a score of zero; a protein with a majority of solubility-promoting aggregation-resistant regions will have a negative score and a protein with a majority of solubility-reducing or aggregation-promoting regions a positive one. Since the sum is divided by the total length of the sequence, typical values of this score are close to zero, and small variations can have a significant impact on the solubility of the protein. In an alternative embodiment, threshold values different from −1, 1 can be employed, in order to make the score more or less sensible to mutations and insertions. The intrinsic solubility score and the structurally corrected one can be very different and in principle uncorrelated, since they are calculated from different profiles. However, when mutations or insertions are performed at sites that are exposed to the solvent, the variations of the two scores always correlate. This is why we use the intrinsic score to scan a large number of possible combinations of mutation and insertion and we calculate the structural correction only for the most promising ones.

One method for defining the structurally-corrected surface solubility or aggregation propensity is to project the intrinsic solubility or aggregation propensity profile onto the surface and smooth it over a surface patch of size S with radius r_{S}. Aⱼ^{int} is the intrinsic aggregation propensity score of residue i which is calculated using the neural networks as described below. The structurally-corrected solubility or aggregation propensity score Aᵢ^{surf} of residue i can be written as a sum which is extended over all the residues of the protein within a distance r_{S} from residue i:

$${A}_{i}^{surf} = {\sum }_{j} {w}_{j}^{D} {w}_{j}^{E} {A}_{j}^{int}$$

$$or$$

$${A}_{i}^{surf} = {w}_{i}^{E} ( {A}_{i}^{int} + {\sum }_{j \neq 1} {w}_{j}^{D} {w}_{j}^{E} {A}_{j}^{int} )$$

where wⱼ^{E} is the “exposure weight” which depends on the solvent exposure of residue j, and wⱼ^{D} is the “smoothing weight”, defined as

$${w}_{j}^{D} = max ( 1 - \frac{{d}_{ij}}{{r}_{s}} , 0 )$$

where dᵢⱼ is the distance of residue j from residue i.

This definition of the smoothing weight guarantees that neighbouring residues contribute more to the local surface solubility or aggregation propensity than more distant ones. Furthermore, the smoothing weight does not bias towards a preselected surface patch size, and thus makes the method applicable to the study of a wide range of interface sizes. In the present work we set r_{S} equal to 10 Å, as this value is consistent with the seven amino acids window implemented in the prediction of the intrinsic profile.

The exposure weight is defined as

$${w}_{j}^{E} = \frac{ϑ ( {x}_{j} - 0.05 )}{1 + {e}^{- a ( {x}_{j} - b )}}$$

where xⱼ is the relative exposure of residue j, i.e. the SASA (solvent accessible surface area) of residue j in the given structure divided by the SASA of same residue in isolation, and θ is the Heaviside step-function, which is employed so that residues less than 5% solvent-exposed are not taken into account.

The equation defining the exposure weight is a sigmoidal function, where a and b are parameters tuned so that the weight grows slowly to a relative exposure x≈20% and then grows linearly reaching 1 at x≈50%. When a residue is 50% solvent-exposed, half of it faces inwards in the structure while the other half, facing the solvent, already provides the largest surface for eventual aggregation partners.

Thus the structurally-corrected solubility or aggregation propensity profile has a value for each residue that is associated to the contribution of that residue to the overall solubility or aggregation propensity. Since this is a structurally-corrected profile, amino acids little exposed to the solvent will get a value that is zero or close to zero.

Returning to FIG. 1a, the next step S106 is to select regions or fragments in the sequence wherein each residue has a score on the profile which is larger than a threshold value, for example one. These fragments correspond to the ‘dangerous’ regions that can reduce solubility or trigger aggregation. At this stage, step S108, we assign to each of these fragments a ranking score, for example the sum of the scores of the residues that are contained in the fragment (i.e. the integral under the profile). This is an easy way to rank the fragments which takes into account both the length (the size of the ‘dangerous’ region) and its aggregation-propensity (how dangerous its components are) but it will be appreciated that other ranking scores may be awarded. We then sort this ranked fragments from less soluble or more soluble, or from more aggregation-prone to less aggregation-prone.

At step S110, we scan through our ensemble of fragments that were selected in the previous steps searching for any residues which were indicated as not to be changed in the first step. These residues are flagged as immutable and thus this step may be considered as filtering the fragments for immutable residues. At least in the case of antibodies, after this filtering, some of the fragments may be completely immutable, as it is quite common for solubility-reducing or aggregation-promoting residues to be found within the CDR loops. Regardless of the number of immutable residues, the position of the fragment in the sequence and in the structure and its ranking score are stored.

The next step S112 is to highlight some positions as candidates for mutations or insertions. Each fragment is considered one at a time. If the fragment still contains some mutable residues, i.e. residues that were not flagged in the previous step, their positions in the sequence are highlighted as possible positions for mutations. If the fragment contains no mutable residues, the positions at the side of the fragment are highlighted as possible positions for mutations/insertions. Each site can either be a candidate for an insertion or a mutation; it cannot be a candidate for both.

It is known that the presence of solubility-promoting or aggregation-resistant residues (such as charged residues or residues that disfavour β-strand formation, like proline or glycine residues) has an effect on the aggregation propensity of the region that contains them. Solubility promoting or aggregation-neutral residues may be defined as ones having a score between −1 and 1 according to our prediction. A list of the known solubility-reducing or aggregation-resistant residues consist in the charged residues (Lysine, Arginine, Glutamic acid and Aspartic acid) with the addition of Proline and Glycine as these two are known to break secondary structures.

Mutating solubility-neutral or aggregation-neutral residues to solubility-promoting or aggregation-resistant at one or both sides of a ‘dangerous’ fragment can significantly increase the solubility or decrease the aggregation propensity of the fragment itself. For this reason we look at the position of the residues adjacent an immutable fragment in the structure. If the amino acid in the adjacent position is solvent exposed and its sidechain is not involved in particular interactions (such as salt bridges, disulphide bonds or hydrogen bonds) its position is flagged for mutation. In addition, if the amino acid is part of some secondary structure (and its backbone hydrogen is involved in hydrogen bond), proline and glycine residues are excluded from the list of possible candidates to replace it. On the other hand, if the adjacent amino acids are not solvent exposed or their side-chains form important interactions, the sides of the solubility-reducing or aggregation-prone fragment are labelled as possible sites for insertions. Furthermore, the sidechain could be part of the hydrophobic core and thus would not be flagged for mutation. However, this is generally accounted for by checking the solvent exposure. (e.g. if it is part of the hydrophobic core then it is not exposed to the solvent).

We now have a list of positions that are suitable for mutations and/or insertions. These positions are mapped on both the sequence and the structure. Each position also has a score (the one given to the fragments before i.e. as calculated in S106-108) that reflects how large the effect on solubility of a mutation/insertion at that site is expected to be. Sites for possible mutation/insertion are therefore ranked. At this point, a choice needs to be made by the user. On one hand it could be desirable to perform mutations/insertions at several position, in order to maximise the solubility of the resulting protein. On the other too many mutations could change the protein too much. This is generally unsuitable for pharmaceutical applications, as one needs to be sure that the resulting protein, after injection, does not trigger an immune reaction in the patient. Moreover, a large number of mutations, even when they are solely on the surface, can affect the stability of the protein, compromising its folding and, consequently, its function.

FIG. 1b illustrates the steps in the method that may be undertaken if a user has specified in the optional input step S102 that at most N mutations (with N often 3 or 4) may be performed. The N positions with higher score are selected. This score may be a combination of the ranking score for the overall fragment and the individual propensity score for the amino acid at that position. For example, if only one position is highlighted for mutation/insertions in each fragment, selecting the N positions will correspond to selecting the N fragments having the highest-ranking score. Each fragment, however, is likely to have more than one selected position and thus selecting the N positions means first selecting the fragment having the highest-ranking score and then selecting the positions within this fragment having the highest individual propensity scores. It is possible that all N positions may be within one fragment. Alternatively, some of the N positions will be within the highest-ranked fragment and the remaining positions will be within the subsequent fragment(s).

A strategy that can be employed to distribute the N mutations/insertions more effectively among the fragments is to first normalize the scores of the fragments. Once the dangerous fragments have been selected and ranked with their scores, such scores are normalized (by dividing each score by the sum of all the scores) so that their sum is equal to one. In this way the mutations/insertions are assigned, always starting from the most dangerous in the ranking, by rounding the product of N times the normalized score to the closer integer and moving down the ranking until all N mutations/insertions have been assigned to some of the positions determined in S112 in the various fragments.

Once the positions are selected, sequences corresponding to every possible combination of mutations and/or insertions at those sites are generated at step S116. Even though each site can only have a mutation or an insertion, this step involves generally a very large number of sequences (N²⁰) because there are 20 types of amino acids that can be used at each position. The number of sequences, however, can be decreased, for example by excluding from the list of candidates the strongly hydrophobic amino acids (i.e. tryptophan and threonine) because it is known that their effect, if any, is to increase the aggregation propensity. Other techniques may also be used to reduce the number of sequences. However, in most cases, it is unlikely to be possible to reduce the number of generated sequences so that the structurally-corrected solubility or aggregation propensity that was calculated for the original sequence can be calculated for each generated sequence in a reasonable time (not least because every sequence needs to be mapped on the structure first).

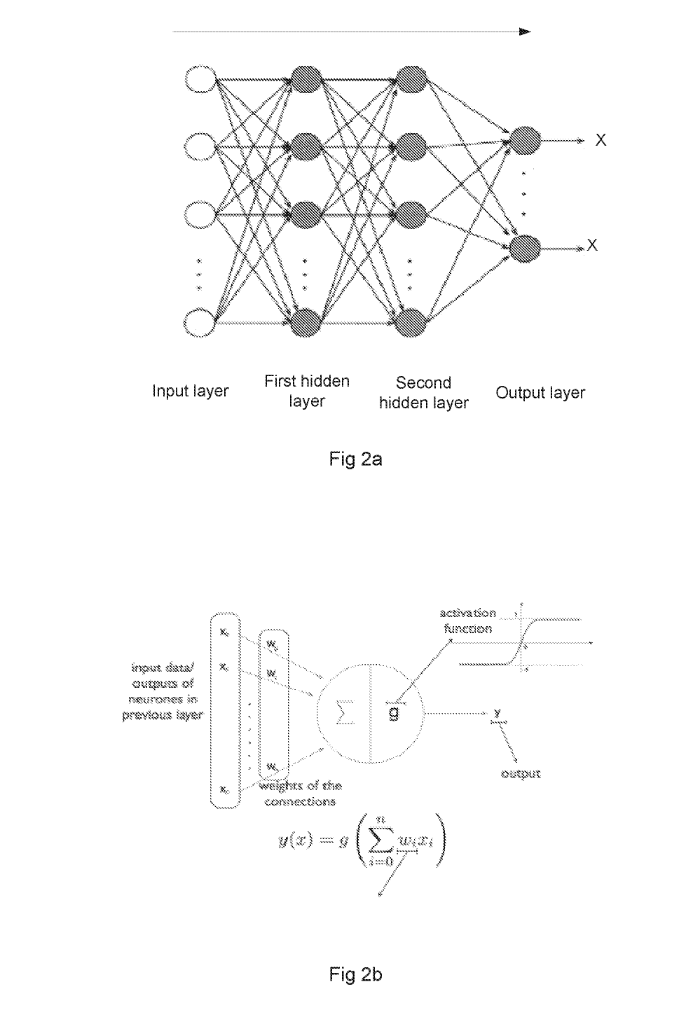

Accordingly, at step S118, an intrinsic solubility or aggregation propensity value is calculated as explained in more detail with reference to FIG. 2a onwards. This method is able to run much faster and, although this value is designed to represent the tendency to aggregate from the unfolded state, the positions at which the mutations/insertions can be performed can be selected on the surface of the protein structure. As a result, the predicted effect of a mutation at one of these sites on the solubility should, to a very good approximation, be the same, whether calculating the structurally-corrected solubility or aggregation propensity of step S104 or intrinsic aggregation propensity of step S118. And indeed this is what we observe in the vast majority of the cases.

Once this calculation is terminated, the mutated sequences are ranked at step S120 using the calculated intrinsic solubility or aggregation propensity. The top m (say m≈10) mutated sequences that are predicted to be the most soluble are selected at step S122. The structurally-corrected solubility or aggregation propensity that was calculated for the original sequence is calculated for each of these top-ranked mutated sequences at step S124. The mutated sequences are ranked at step S126 using the calculated structurally-corrected solubility or aggregation propensity in order to double-check the ranking and to obtain a more accurate solubility score. It will be appreciated that the calculation of the structurally-corrected solubility or aggregation propensity and the double-checking of the ranking step is optional.

The mutated sequences and their solubility scores are output in ranked order at step S128. The output thus listed the most soluble protein sequences that are obtainable with the given number of mutations, i.e. without changing the protein too much.

One could now select the sequence with the highest solubility, or could consider carrying out another refinement step. This step entails using one of the many available algorithms that calculate the effect of a mutation/insertion on the stability of the protein (i.e. ΔΔG). See for example Zhang Z1, Wang L, Gao Y, Zhang J, Zhenirovskyy M, Alexov E “Predicting folding free energy changes upon single point mutations” in Bioinformatics 2012, 28(5):664-671 (http://www.ncbi.nlm.nih.gov/pubmed/22238268); Li Y1, Fang J “PROTS-RF: a robust model for predicting mutation-induced protein stability changes” in PLoS One. 2012; 7(10):e47247 (http://www.plosone.org/article/info%3Adoi%2F10.1371%2Fjournal.pone.0047247); Thiltgen G1, Goldstein R A “Assessing predictors of changes in protein stability upon mutation using self-consistency in PLoS One. 2012; 7(10):e46084 (http://www.plosone.org/article/info%3Adoi%2F10.1371%2Fjournal.pone.0046084); or Capriotti E1, Fariselli P, Casadio R “I-Mutant2.0: predicting stability changes upon mutation from the protein sequence or structure” in Nucleic Acids Res. 2005; 33:W306-10 (http://gpcr2.biocomp.unibo.it/˜emidio/I-Mutant2.0/I-Mutant2.0_Details.html).

This could be helpful as, in the majority of the cases, the m more soluble sequences will have a very similar solubility, hence scoring them with the sum of the ΔΔG-s of all the mutations/insertions they contain, could be a useful way to select the best one. As already mentioned, however, since our mutation sites are selected on the surface of the protein, the ΔΔG values of mutations at these sites should be close to zero. Therefore this further refinement is not expected to add much to the prediction.

FIG. 1c shows the steps for an alternative method to that shown in FIG. 1b, for example when a maximum number of mutations has not been input or is not used. An alternative optional input can be given. Rather than constraining the number of mutations/insertions to perform, one might wish to stop doing mutations when a given solubility is reached. This choice is also possible with this algorithm, even though it requires some calibration with experimentally measured solubility values (i.e. the critical concentrations). In fact the structurally-corrected solubility or aggregation propensity score computed by the algorithm strongly correlates with experimentally measured solubility values (R² above 0.95). However the coefficients of the linear fit may change from protein family to protein family, even though they are approximately the same within the same protein family (for example for different antibodies).

In this method, the initial step S130 is to select the top site from the sites selected in step S112. The top site is the one with the highest fragment score and the highest score within that fragment. At step S132, all possible mutations are performed at this site and the new intrinsic aggregation propensity for each mutated sequence is calculated using the predictor as set out at S134. The mutated sequences are ranked according to this calculated propensity at S136. Thus, steps S132 to S136 are the same as steps S116 to S120 in the previous method except that the mutations are being performed at only one site.

The methods diverge at this stage. At step S138, the best mutation (i.e. highest-ranked sequence) is selected rather than the top m sequences as in the previous arrangement. The structurally-corrected score is then calculated for this top ranked sequence (S140). It then extrapolates the solubility using the correlation coefficients calculated from the fit of the experimental data. For example, in the case of single domain antibodies, the coefficient in FIG. 7 can be used, so the critical concentration (i.e. the solubility) will be: (−844.2*structurally-corrected score+81.5) uM. Then a comparison of the solubility is made using the input threshold value (S144). If the extrapolated solubility is larger than the desired solubility, the method stop and the mutated sequence is output S146. However, if the extrapolated solubility is not larger than the desired solubility, the next ranked site is selected and steps S132 onwards are repeated. In other words, the method reiterates through the steps of mutation, calculate of intrinsic propensity, ranking, calculating structurally-corrected propensity and until the desired value is reached.

FIG. 2a onwards show how the intrinsic aggregation propensity is calculated or predicted. A machine learning technique is used. In this particular application we used Artificial Neural Networks (ANNs). ANNs are a mathematical model able to learn patterns and recognise rules. If properly trained a neural network can approximate unknown functions. One example that has been demonstrated to work is a feed-forward neural network as shown in FIG. 2a. This neural network comprises an input layer comprising a plurality of neurons each of which receive an input. The neurons in the input layer are each connected to a plurality of neurons in a first hidden layer that in turn connect to a plurality of neurons in a second hidden layer. Inputs propagate through the network where they are processed by each layer until the output X exits from the output layer. Such networks are well known in the art and may comprise any number of hidden layers.

FIG. 2b is an illustration of an artificial neuron that may be used at each layer of the network of FIG. 2a. Each neuron receives n real numbers (x₀, x₁ . . . xₙ) as input from the neurons in the previous layer or directly from the input layer. Each of these inputs ‘reaches’ the neuron through a connection that has a weight w (w₀, w₁ . . . wₙ). Once the neuron receives the input it ‘fires’ an output y according to

$$y ( x ) = g ( {\sum }_{i = 0}^{n} {w}_{i} {x}_{i} )$$

where the sum is over the n connections that enter in the neuron and the function g, specific to the neuron, is called activation function.

The activation function can be very general; the most common examples are a threshold, a symmetric threshold, a sigmoid, a symmetric sigmoid, a stepwise sigmoid and also linear functions. A symmetric sigmoid is implemented in the current version and is illustrated in FIG. 2b, but a different function can be chosen by simply changing a parameter in the algorithm. When the network is trained on a known set of inputs and outputs the weights of the connections are determined in order to reproduce the correct output starting from the known input. For this reason the network architecture (the number of input neurons, output neurons, hidden layers and neurons in the hidden layers) and the size and diversity of the training set are of key importance for its successful employment in predicting a given property.

The deterministic neural network may be, for example, a non-linear multilayer perceptron. Here, by non-linear, it is meant that one or more layers of neurons in the network have a non-linear transfer function so that the network is not constrained to fit just linear data. The skilled person will recognise that, in principle, the mapping need not be performed by a neural network but may be performed by any deterministic function, for example a large polynomial, splines or the like, but in practice such techniques are undesirable because of the exponential growth in the number of parameters needed as the length of the input/output vectors increases.

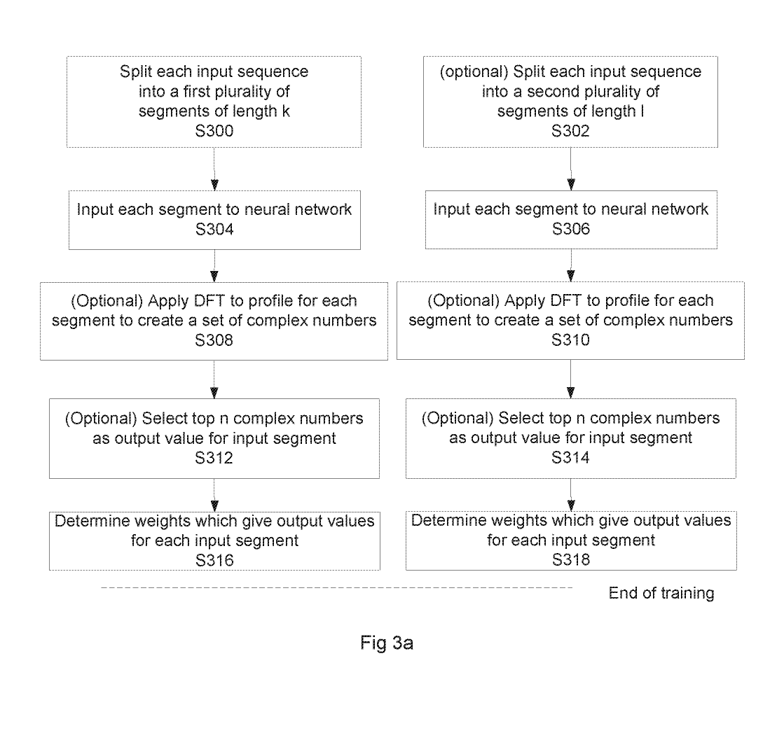

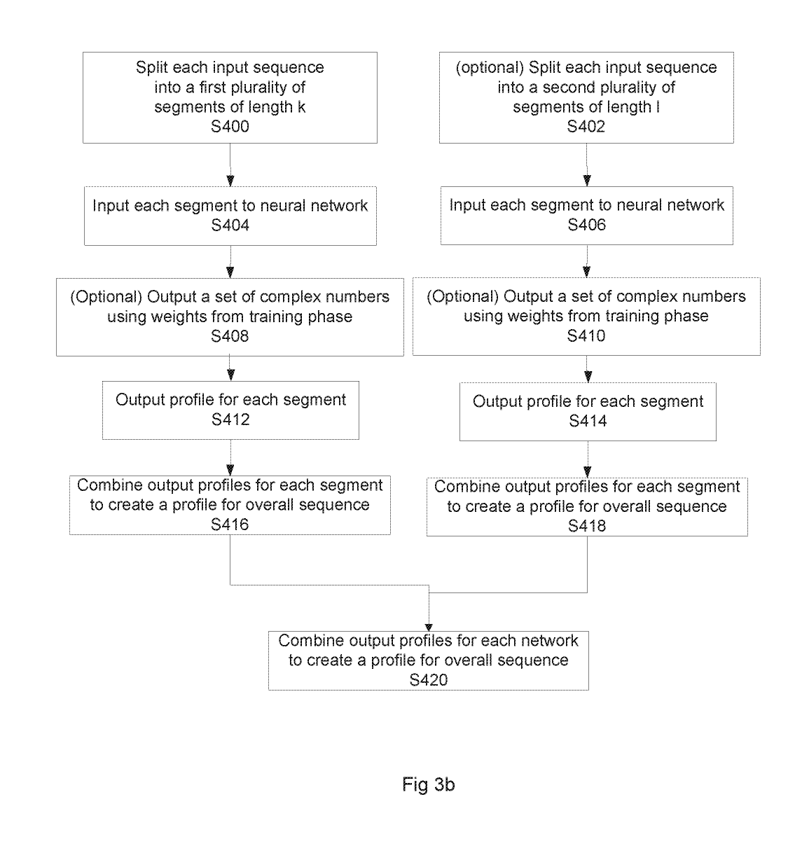

FIGS. 2a and 2b illustrate standard neural network theory. FIG. 3 onwards illustrate how a sequence and its associated profile of intrinsic aggregation propensity are processed, so that a neural network can be successfully trained and subsequently employed in prediction.

A neural network requires a fixed number of input neurons but sequences have variable length. To overcome this problem, as illustrated in FIG. 3, the first step S300 is to split every input protein sequence into a plurality of segments each having the same number of amino acids (say k). As a consequence, a single sequence is split into multiple segments. This splitting could lead to potential problems at the boundaries of the segments because the influence of neighbouring residues belonging to different segments would be neglected. The effect of the splitting can be reduced in two ways.

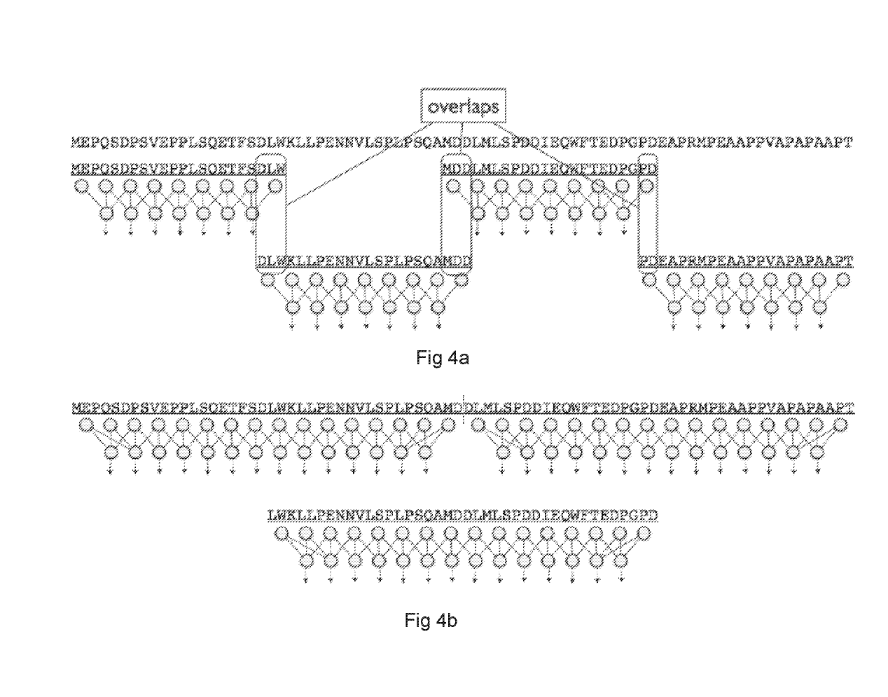

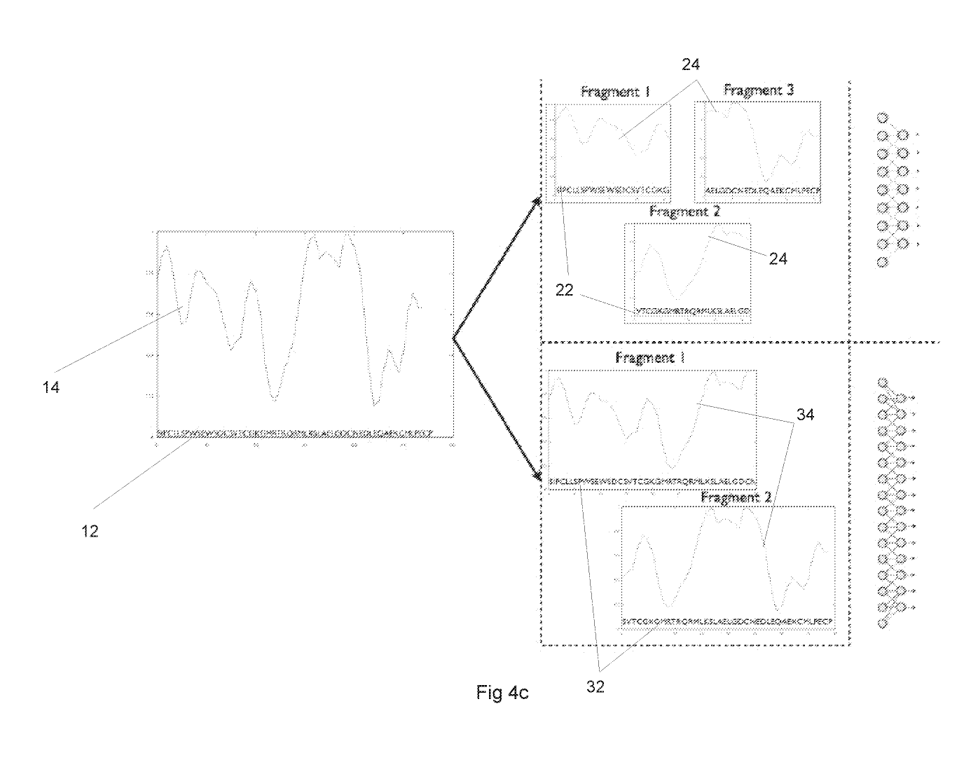

As shown in FIG. 4a, one method is to define each segment so that there is a small overlapping region (of say two to four, perhaps three residues) with the adjacent segment(s). The minimum overlap is at least 1 amino acid. In this way, when the results for each segment are merged in the profile for the actual sequence as explained in more detail below, an average is done for the overlapping amino acids. Thus, the influence of residues on adjacent residues is preserved. The use of overlapping regions also means that the overlap regions can be adjusted to ensure that each segment has a uniform length. For example, if the overall sequence was not a multiple of k, the final segment would only have the remaining residues therein. By adjusting the overlapping regions appropriately, we can ensure that all segments are of length k.

As shown in FIG. 4b, another method may be used in conjunction with or separately from the method of FIG. 4a to split every input protein sequence into a second plurality of segments each having the same number of amino acids (say l). The two sets of segments are then processed separately by two networks with the results from each network being averaged as explained in more detail below. Examples of suitable values for k and l are 22 and 40 positions respectively (corresponding to 440 and 800 neurons in the input layer of each network). It is essential that the two values k, l are not the same or multiples of each other; otherwise the same positions will be ignored. These numbers are again parameters, however, so any different combination can be employed. As will be appreciated from FIG. 4b, splitting the sequence into segments having a longer length l means that the overlapping regions may also be longer, e.g. to ensure that the segments have uniform length.

Returning to FIG. 3, this step S302 of separating the sequence into a second plurality of segments is shown as a parallel step. Thereafter, both sets of segments are input into their appropriate neural network (S304, S306). Both the input and the output of a neural network are real numbers. Accordingly, the sequence that is letter based needs to be translated into numbers. One way of achieving this result is for the neural network to comprise an input layer having 20 neurons for each position in the input sequence, each of the 20 neurons representing a different kind of amino acid. These 20 neurons are all switched off (set to zero) except for the one that represents the particular amino acid that is found at that position, which is set to one.

As explained above, the neural network first needs to be trained before it can be used to perform predictions. Accordingly, the segments need to be input with an output value. FIG. 4c shows the advantage of splitting each sequence into a plurality of segments. The original sequence 12 together with its known propensity value 14 (shown as a profile across all the positions) is separated in a first plurality of segments 22 with known propensity values 24. Thus, the training set is increased from one sequence to the total number of fragments (in this illustrative example, three). Furthermore, the original sequence 12 may also be separated into a second plurality of segments 32 with known propensity values 34. In this case, the separation into segments increases the training set for the second network from one to two.

The output value may be the known value for the propensity as represented by the profiles in FIG. 4c. Another optional adaptation that may be used in the present invention is to train the neural networks to predict the first n Fourier coefficients of the profile, rather than the profile itself. Thus, returning to FIG. 3, the first step is to convert each profile which is a set of M real numbers (x₀, x₁, . . . , x_{M-1}) to a set of complex numbers Xₖ using a Fourier transform such as a discrete Fourier Transform (DFT) where

$${X}_{k} = {\sum }_{n = 0}^{M - 1} {x}_{n} \cdot {e}^{- i 2 π \frac{k}{M} n}$$

The set of numbers is thus reduced to a smaller set of complex numbers:

$$( {X}_{0} , {X}_{1} , … , {X}_{\frac{M}{2} - 1} )$$

The last coefficients (i.e. lower set of complex numbers) of the Discrete Fourier Transform may be ignored without comprising the output. In this way, a smaller number of output neurons are required. In the output layer, a reverse Fourier transform is applied to recreate the profile. For the DFT above, the reverse transform may take the form

$${x}_{n} = \frac{1}{M} {\sum }_{k = 0}^{M - 1} {X}_{k} \cdot {e}^{- i 2 π \frac{k}{M} n}$$

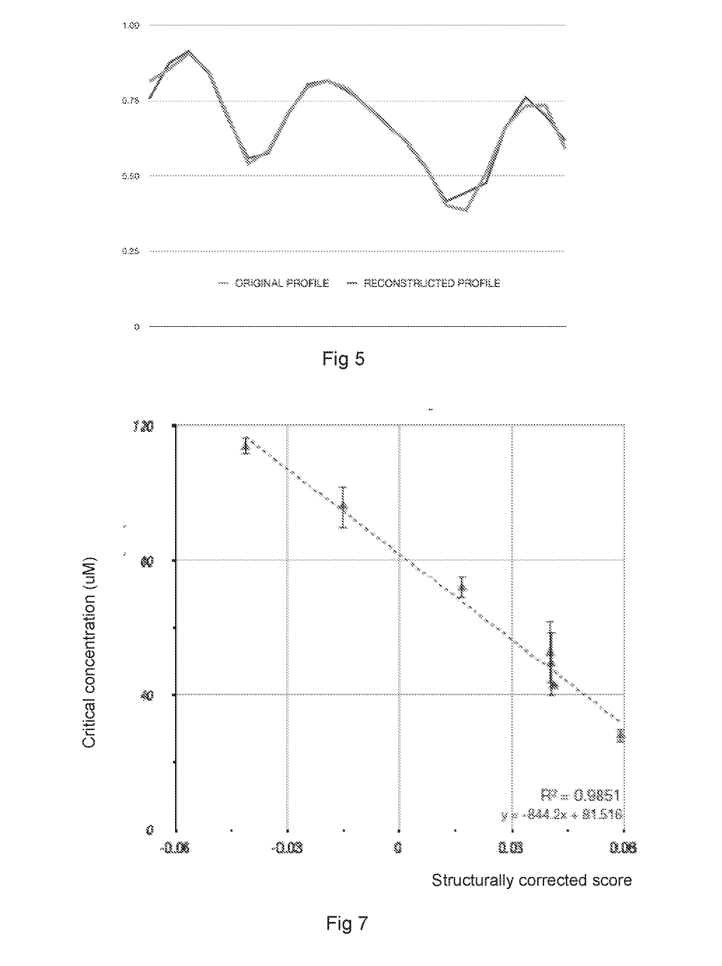

FIG. 5 plots one profile that has been converted using the DFT above and reconstructed using only six of the complex numbers generated (those not used are shown in italics). The table below gives the coefficients of the original profile, the complex numbers and the coefficients of reconstructed profile. As shown in the table and FIG. 5, the reconstructed profile is a good approximation for the original profile. By predicting only half of the coefficients, the improvement in the accuracy of the neural network appears to have compensated (even outbalanced) the error introduced by reconstructing the profile from only half of the coefficients.

| | Real part | Imaginary part | Reconstructed |
|---|---|---|---|
| Original coefficients | (after DFT) | (after DFT) | coefficients |
| 0.812000 | 14.88700 | 0.000000 | 0.754622 |
| 0.854000 | 0.532208 | −1.129558 | 0.873456 |
| 0.905000 | 1.290772 | 0.356902 | 0.913422 |
| 0.847000 | −0.44553 | −0.567877 | 0.839057 |
| 0.693000 | −0.69973 | −0.515733 | 0.683762 |
| 0.540000 | 0.037849 | −0.130199 | 0.558127 |
| 0.582000 | | | 0.573401 |
| 0.707000 | 0.141788 | −0.012921 | 0.700636 |
| 0.794000 | 0.095783 | −0.171094 | 0.803187 |
| 0.815000 | 0.116615 | −0.127928 | 0.815915 |
| 0.789000 | 0.135195 | −0.059814 | 0.780141 |
| 0.728000 | 0.177062 | −0.027005 | 0.731982 |
| 0.667000 | 0.213000 | 0.000000 | 0.673356 |
| 0.614000 | | | 0.607190 |
| 0.526000 | | | 0.520902 |
| 0.401000 | | | 0.415122 |
| 0.385000 | | | 0.444509 |
| 0.510000 | | | 0.475797 |
| 0.664000 | | | 0.661776 |
| 0.732000 | | | 0.759525 |
| 0.733000 | | | 0.700033 |
| 0.589000 | | | 0.615094 |

Moreover, as mathematically the Fourier coefficients represent the oscillatory modes of the profile, the network that covers a sequence segment of smaller length k (suppose k<l) is better suited to capture high frequency modes, while the other one to capture low frequency modes. Therefore the employment of two networks not only helps to solve the fixed length problem but also to increase the accuracy of the reconstruction from the Fourier coefficients.

Returning to FIG. 3a, the final step of the training phase comprises determining the weights for the neural network that give the output values associated with each input segment (S316, S318). The output values may be profiles or may be created as explained in relation to FIG. 5 by applying a Fourier transform to the profile for each segment (3308. S310) and selecting the top n complex numbers from this transformation (S312, S314).

Once each network has been trained, it can be used to predict output values as shown in FIG. 3b. To ensure a valid prediction, the sequence needs to be given as input in the same manner as the training sequences. As shown in FIGS. 3a and 3b, two neural networks are simultaneously used per property of interest. Of these two, one (a “short” neural network) is trained on short segments (e.g. 22 amino acids) and the other one (a “long” neural network) on long segments (e.g. 40 amino acids). Preferably there is an overlap of at least 1 amino acid (but it varies depending on the length of the sequence) between consecutive segments. Where the optional Fourier transform is used, the short network predicts 6 Fourier coefficients and the long one 11 Fourier coefficients. The Fourier coefficients are complex numbers and thus there need to be 12 output neurons in the “short” network and 22 in the “long” network respectively. The lengths of the segments were chosen empirically as the ones that allowed for the smaller error in the training. To computationally implement the networks the FANN library (Fast Artificial Neural Network) was employed (see Nissen, S. (2003). Implementation of a Fast Artificial Neural Network Library (FANN), http://leenissen.dk/fann/ (Copenhagen: University of Copenhagen. Department of Computer Science).

Accordingly, the first step in the prediction sequence shown in FIG. 3b is to split the input sequence into the first and second plurality of segments (S400, S402) preferably with overlapping regions as previously described. Each segment is then given as input to the neural network (S404, S406). This time, the weights determined in the training phase are used to predict the output value for each segment.

Where we are predicting the intrinsic aggregation propensity for the sequence, the final output is the profile. Where the Fast Fourier methodology has been used, the output values that are predicted are the complex coefficients (S408, S410). These complex coefficients are then converted to the profile by using the inverse Fourier transform as described. Each segment has its own output profile (S412, S414); these profiles are than combined to create an output profile for the associated network (S416, S418). In the overlapping regions, the profiles are simply averaged to create the combined profile. Finally, at step S420, the profile from each neural network is averaged to provide a combined output profile.

The averaging can be done by carrying out a smoothing over a window of seven residues by carrying out an averaging. This step is done to strengthen the influence that residues in the sequence have on their vicinity and to reduce the noise of the profile, highlighting regions rather than single residues.

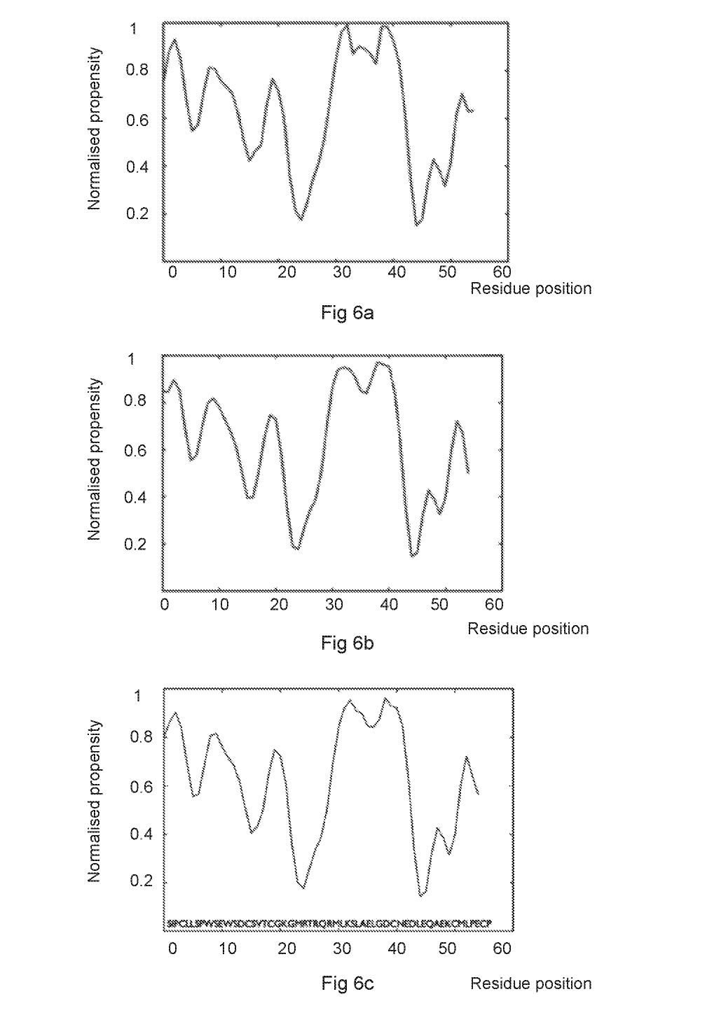

FIG. 6a shows the combined output profile for the first “short” network that was created using the output profiles for each segment. FIG. 6b shows the combined output profile for the first “long” network using the output profiles for each segment. FIG. 6e shows the combined output profile from the two networks. Positive peaks in the intrinsic aggregation propensity profiles correspond to aggregation-prone regions, and negative peaks to aggregation-resistant regions.

### Experimental Validation

To experimentally validate the predictor of FIG. 3a onwards, a refoldable human VH single domain (HEL4) has been used because this is easily expressed in yeast and bacteria. More specifically, we employed a gammabody (Grafted-Amyloid Motif Antibodies) that targets the Aβ peptide and we performed mutations and insertions on its scaffold to solubilize it.

The algorithm of FIG. 1 described above picked three different sites where mutations could significantly impact the solubility or aggregation-propensity of the gammabody. The most relevant one was actually an insertion site right next to the grafted fragment (which, being the binding site, could not be changed) and two others are mutation sites in one of the β-strands in the scaffold. On these sites we selected six different combinations of mutations and insertions in order to explore a range of different effects on the solubility of the gammabody (the six variants are listed in Annex 1—Annex1—Protein variants employed).

The values of the score predicted using the method above, the critical concentration that was experimentally determined and the error between the measured and the predicted concentration are reported in the table below. These results are also plotted in the correlation plot of FIG. 7. The two correlate extremely well (R²=0.99). The negative correlation is expected as the calculated structurally-corrected score depicts the tendency that a protein has to aggregate from its native state; the greater is this tendency the smaller is the solubility of the molecule

| | Structurally- | Measured Critical | Error |
|---|---|---|---|
| Gammabody variant | corrected Score | Concentration (uM) | (uM) |
| Aβ33-42 DED | 0.017 | 71.36609 | 3.3 |
| Aβ33-42 EEE | −0.015 | 95.60 | 6.5 |
| Aβ33-42 EEP | −0.041 | 113.41 | 2.5 |
| Aβ33-42 NNK | 0.040 | 48.75 | 9.5 |
| Aβ33-42 Q118K | 0.041 | 42.33 | 0.3 |
| Aβ33-42 Q118K/L121E | 0.040 | 52.27 | 9.5 |
| Aβ33-42 Wt | 0.059 | 27.62 | 2 |

The wild type has a predicted score of 0.059 and a measured critical concentration of 27.6. The six variants have scores ranging between −0.015 and 0.041 and measured concentrations varying between 42.3 and 113.4 μM. Accordingly, some of the mutations only have a small effect on the solubility or aggregation propensity whereas some of the mutations (e.g. Aβ33-42 EEP) change it radically. Every mutation or insertion we have tried was predicted using the algorithm described above. Since, however, we wanted to validate the goodness of our predictions, we did not simply select the most solubilizing combination of mutations and insertions as described previously, but we tried to screen a wider range of solubility values.

The critical concentration of the wild type and of these variants was measured. Gammabody Aβ33-42 mutant variants were obtained by employing phosphorylated oligonucleotide PCR or Quick Change XLII kit (Qiagen) on the wild type variant cDNA, depending on the kind of the mutation. The different gammabodies were expressed in E. coli BL21 (DE3)-pLysS strain (Stratagene) for 24 h at 30° C. using Overnight Express Instant TB Medium (Novagen) supplemented with ampicillin (100 μg/mL) and chloramphenicol (35 μg/mL). Cellular suspension was therefore centrifuged twice at 6000 rcf and the supernatant incubated with 2.5 mL/L of supernatant of Ni-NTA resin (Qiagen) at 18° C. overnight in mild agitation. The Ni-NTA beads were collected and the protein eluted in PBS pH 3, neutralized at pH 7 upon elution. The protein purity, as determined by SDS-PAGE electrophoresis, exceeded 95%. Solutions of the purified proteins were then divided into aliquots, flash-frozen in liquid nitrogen and stored at 80° C.; each protein aliquot was thawed only once before use. Protein concentrations and soluble protein yields were determined by absorbance measurements at 280 nm using theoretical extinction coefficients calculated with Expasy ProtParam.

In order to determine the critical concentration (cc) of the gammabody variants (i.e. the higher concentration at which the gammabodies are able to keep their native monomeric conformations), protein samples at different concentrations were obtained by centrifugation steps using AmiconUltra-0.5, Ultracel-3 Membrane, 3 kDa (Millipore), incubated for 30 min at room temperature and ultracentrifuged at 90000 rpm for 45 min at 4° C. Protein concentration of the resulting supernatant was plotted as a function of the starting protein concentration, before ultracentrifugation, of the solution and analysed using an exponential equation assuming the top asymptote corresponding to the Critical Concentration value.

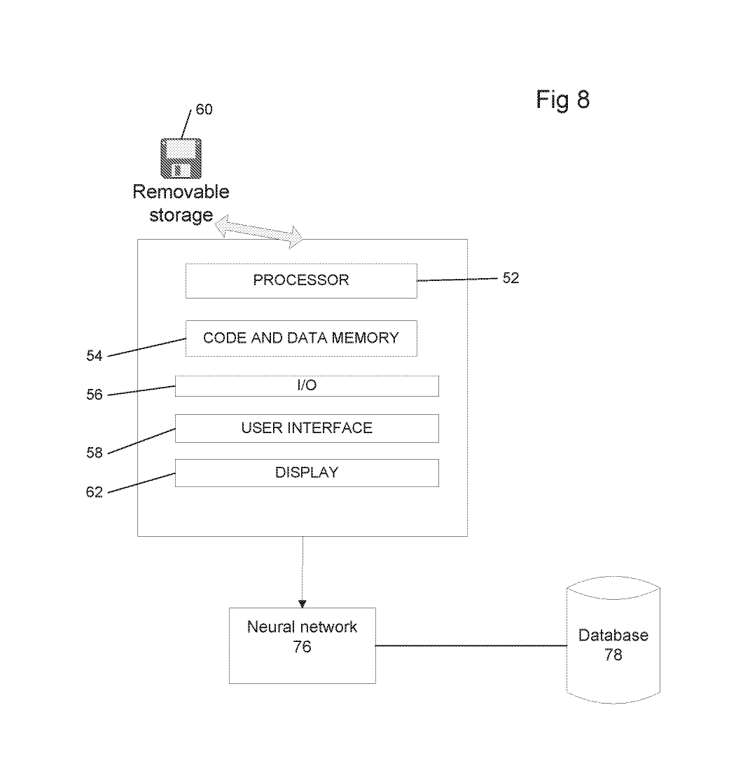

FIG. 8 shows a schematic block diagram of a system that can be used to implement the methods of FIGS. 1a to 1c and 3. The system comprises a server that comprises a processor 52 coupled to code and data memory 54 and an input/output system 56 (for example comprising interfaces for a network and/or storage media and/or other communications). The code and/or data stored in memory 54 may be provided on a removable storage medium 60. There may also be a user interface 58 for example comprising a keyboard and/or mouse and a user display 62. The server is connected to a neural network 76 that is itself connected to a database 78. The database 78 comprises the sequences and known output values against which the neural network is trained. The user database and neural network are shown as a separate component but may be integrated into the same device.

In FIG. 8, the server is shown as a single computing device with multiple internal components which may be implemented from a single or multiple central processing units, e.g. microprocessors. It will be appreciated that the functionality of the device may be distributed across several computing devices. It will also be appreciated that the individual components may be combined into one or more components providing the combined functionality. Moreover, any of the modules, databases or devices shown in FIG. 8 may be implemented in a general-purpose computer modified (e.g. programmed or configured) by software to be a special-purpose computer to perform the functions described herein.

The processor of FIG. 8 may be configured to carry out the steps of FIGS. 1a to 1c. The user interface may be used to input the sequence and any residues which are not to be changed together with the optional input relating to the maximum number of mutations and desired output value. The output ranking or mutated sequence may be displayed on the user display. The processor may also be configured to carry out the splitting and inputting steps of FIG. 3a with the remaining steps being carried out at the neural network. Similarly, the processor may also be configured to carry out the splitting, inputting and combining steps of FIG. 3b with the remaining steps being carried out at the neural network.

No doubt many other effective alternatives will occur to the skilled person. It will be understood that the invention is not limited to the described embodiments and encompasses modifications apparent to those skilled in the art lying within the spirit and scope of the claims appended hereto.

ANNEX 1
Protein variants employed
for experimental validation

Aβ33-42 wt
(SEQ ID NO: 1)
(HindIII-KL)- E V Q L V E S G G G L V Q P G G S
L R L S C A A S G F N I K D T Y I G W V R R A P
G K G E E W V A S I Y P T N G Y T R Y A D S V K
G R F T I S A D T S K N T A Y L Q Met N S L R A
E D T A V Y Y C A A (BamHI-G S) Aβ Sequence
(NotI-A A A) W G Q G T L V T V S S-(KpnI-GT)-
AA-DYKDDDDK-AA-DYKDDDDK-AA-DYKDDDDK-AA-HHHHHHH-
(STOP)-(XhoI)
Aβ33-42 Q118K
(SEQ ID NO: 2)
(HindIII-KL)- E V Q L V E S G G G L V Q P G G S
L R L S C A A S G F N I K D T Y I G W V R R A P
G K G E E W V A S I Y P T N G Y T R Y A D S V K
G R F T I S A D T S K N T A Y L Q Met N S L R A
E D T A V Y Y C A A (BamHI-G S) Aβ Sequence
(NotI- A A A) W G K G T L V T V S S-(KpnI-GT)-
AA-DYKDDDDK-AA-DYKDDDDK-AA-DYKDDDDK-AA-HHHHHHH-
(STOP)-(XhoI)
Aβ33-42 Q118K/L121E
(SEQ ID NO: 3)
(HindIII-KL)- E V Q L V E S G G G L V Q P G G S
L R L S C A A S G F N I K D T Y I G W V R R A P
G K G E E W V A S I Y P T N G Y T R Y A D S V K
G R F T I S A D T S K N T A Y L Q Met N S L R A
E D T A V Y Y C A A (BamHI-GS) Aβ Sequence
(NoI- A A A) W G K G T E V T V S S-(KpnI-GT)-
AA-DYKDDDDK-A-DYKDDDDK-AA-DYKDDDDK-AA-HHHHHHH-
(STOP)-(XhoI)
Aβ33-42 NNK
(SEQ ID NO: 4)
(HindIII-KL)- E V Q L V E S G G G L V Q P G G S
L R L S C A A S G F N I K D T Y I G W V R R A P
G K G E E W V A S I Y P T N G Y T R Y A D S V K
G R F T I S A D T S K N T A Y L Q Met N S L R A
E D T A V Y Y C A A (BamHI-GS) Aβ Sequence
N N K (NotI- A A A) W G Q G T L V T V S S-
(KpnI-GT)-AA-DYKDDDDK-AA-DYKDDDDK-AA-DYKDDDDK-
AA-HHHHHHH-(STOP)-(XhoI)
Aβ33-42 DED
(SEQ ID NO: 5)
(HindIII-KL)- E V Q L V E S G G G L V Q P G G S
L R L S C A A S G F N I K D T Y I G W V R R A P
G K G E E W V A S I Y P T N G Y T R Y A D S V K
G R F T I S A D T S K N T A Y L Q Met N S L R A
E D T A V Y Y C A A (BamHI-GS) Aβ Sequence
D E D (NotI- A A A) W G Q G T L V T V S S-
(KpnI-GT)-AA-DYKDDDDK-AA-DYKDDDDK-AA-DYKDDDDK-
AA-HHHHHHH-(STOP)-(XhoI)
Aβ33-42 EEE
(SEQ ID NO: 6)
(HindIII-KL)- E V Q L V E S G G G L V Q P G G S
L R L S C A A S G F N I K D T Y I G W V R R A P
G K G E E W V A S I Y P T N G Y T R Y A D S V K
G R F T I S A D T S K N T A Y L Q Met N S L R A
E D T A V Y Y C A A (BamHI-GS) Aβ Sequence
E E E (NotI- A A A) W G Q G T L V T V S S-
(KpnI-GT)-AA-DYKDDDDK-AADYKDDDDK-AA-DYKDDDDK-
AA-HHHHHHH-(STOP)-(XhoI)

1-39. (canceled)

40. A method of identifying mutations or insertions that alter a property such as the solubility or aggregation propensity of an input polypeptide chain, the method comprising
inputting a sequence of amino acids for said input polypeptide chain;
calculating a structurally corrected solubility or aggregation propensity value for said target polypeptide chain, wherein the solubility or aggregation propensity value is a profile having a value for each amino acid in the sequence;
selecting, using said calculated profile, aggregation-prone regions within said target polypeptide chain, wherein said aggregate-prone region is a region wherein each residue has a score on the profile larger than a threshold value;
identifying at least one position within or either side of each selected region suitable for mutations or insertions;
generating a plurality of mutated sequences by mutations or insertions at least one identified position; and
predicting a value of the solubility or aggregation propensity for each of the plurality of mutated sequences whereby any alteration to the solubility or aggregation propensity of the input polypeptide chain is identified, wherein predicting a value for solubility or aggregation propensity comprises:
inputting each of the plurality of mutated sequences as an input polypeptide chain into a data processing system comprising a first trained neural network having a first function mapping an input to a first output value and a second trained neural network having a second function mapping an input to a second output value;
generating a first output value of said solubility or aggregation propensity for each said input polypeptide chain using said first trained neural network, wherein generating said first output value of said solubility or aggregation propensity for each said input polypeptide chain using said first trained neural network comprises:
dividing each said input polypeptide into a plurality of segments each having a first fixed length,
inputting each amino acid in each segment to the first neural network;
using the first function to map the input amino acids to a first segment output value for each segment;
generating a second output value of said solubility or aggregation propensity for each said input polypeptide chain using said second trained neural network, wherein generating said second output value of said solubility or aggregation propensity for each said input polypeptide chain using said second trained neural network comprises:
dividing said input polypeptide chain into a plurality of segments each having a said second length which is greater than said first length,
inputting each amino acid in each segment to the second neural network and
using the second function to map the input amino acids to a second segment output value for each segment; and
combining the second segment output values to generate said second output value; and
combining the first and second output values to determine a combined output value for the solubility or aggregation propensity.

41. The method of claim 41, wherein the data processing system is trained by:
training said first neural network in said data processing system using a set of polypeptide chains having known sequences of amino acids and known values for the solubility or aggregation propensity to determine a first function which maps the known sequences to the known values, wherein said training comprises
dividing each polypeptide chain in said set of polypeptide chains into a plurality of segments, with each segment having a first fixed length;
inputting each segment into said first neural network by representing each amino acid in each segment using an input neuron in the first neural network; and
determining said first function from said input segments and said known values;
training said second neural network in said data processing system using said set of polypeptide chains to determine a second function which maps the known sequences to the known values, wherein said training comprises
dividing each polypeptide chain in said set of polypeptide chains into a plurality of segments each having a second fixed length; wherein said second length is greater than said first length;
inputting each segment into said second neural network by representing each amino acid in each segment using an input neuron in the second neural network; and
determining said second function from said input segments and said known values.

42. The method according to claim 41, wherein the first and second neural networks are trained simultaneously.

43. The method according to claim 41, wherein the known value is an aggregation propensity value, and wherein the method comprises applying a Fourier transform to the profile to determine a set of Fourier coefficients, wherein preferably the method comprises using a subset of the set of Fourier coefficients as the known values.

44. The method according to claim 41, wherein the first and second segment output values are a set of Fourier coefficients which are converted by applying an inverse Fourier transform.

45. The method according to claim 41, wherein the second length is not a multiple of the first length, and wherein preferably the first length is 22 and the second length is 40.

46. The method according to claim 41, wherein at each dividing step, the polypeptide chain is divided into a plurality of segments each having an overlapping region with adjacent segments, wherein preferably, the overlapping region comprises at least one amino acid which is present in both adjacent segments and at most n−1 amino acids when n is the length of the segments.

47. A method of identifying poorly soluble or aggregation-prone regions in a target polypeptide chain, the method comprising predicting a value for solubility or aggregation propensity using the method of claim 40, comparing the predicted values against a threshold value and identifying the poorly soluble or aggregation-prone regions as regions having predicted values above the threshold value.

48. The method of claim 40, further comprising ranking the identified positions and using the ranking to generate the plurality of mutated sequences, wherein preferably the method comprises choosing the top ranked position and generating the plurality of mutated sequences by applying a plurality of mutations and/or insertions at that position.

49. The method of claim 48 comprising determining whether any of the predicted values for solubility or aggregation propensity is higher than a threshold value and when the predicted value is higher than the threshold value, outputting the mutated sequence as a target polypeptide chain and when the predicted value is lower than the threshold value, reiterating the choosing, generating and determining steps at the next ranked position until the predicted value is higher than the threshold value.

50. The method of claim 48 comprising choosing a set of the top ranked positions and generating the plurality of mutated sequences by applying a plurality of mutations and/or insertions at that set of positions, wherein preferably the method further comprises ranking the predicted value for solubility or aggregation propensity for each mutated sequence and outputting the highest ranked mutated sequences with their values as the output polypeptide chains.

51. The method of claim 40, comprising identifying any positions at which mutations or insertions are prohibited and flagging such positions as immutable so that in the generating steps no mutations or insertions are applied at these positions, wherein if all the positions in a selected region are flagged as immutable, the positions at the side of the selected region are identified as positions suitable for mutations or insertions.

52. The method of claim 40 wherein the polypeptide chain is selected from the group comprising a protein hormone, antigen, immunoglobulin, repressors/activators, enzymes, cytokines, chemokines, myokines, lipokines, growth factors, receptors, receptor domains, neurotransmitters, neurotrophins, interleukins, interferons and nutrient-transport molecules, wherein preferably the polypeptide chain is a CDR-containing peptide, preferably an antibody or antigen-binding fragment thereof.

53. A data processing system for identifying mutations or insertions that alter the solubility or aggregation propensity of an input polypeptide chain, the system comprising:
a processor configured to:
receive an inputted sequence of amino acids and a structure for said sequence for said target polypeptide chain;
calculate a structurally corrected solubility or aggregation propensity profile for said target polypeptide chain;
select, using said calculated profile, regions within said target polypeptide chain;
identify at least one position within each selected region suitable for mutations or insertions;
generate a plurality of mutated sequences by mutations or insertions at least one identified position; and
predict a value of the solubility or aggregation propensity for each of the plurality of mutated sequences whereby any alteration to the solubility or aggregation propensity of the input polypeptide chain is identified;
a first neural network which has a first function mapping an input to a first output value and which is configured to generate said first output value of said solubility or aggregation propensity for each of the plurality of mutated sequences; and
a second neural network which has a second function mapping an input to a second output value and which is configured to generate said second output value of said solubility or aggregation propensity for each of the plurality of mutated sequences; wherein
the processor is further configured to:
predict the value of the solubility or aggregation propensity by combining the first and second output values to determine a combined output value for the solubility or aggregation propensity.

54. The data processing system as claimed in claim 53 wherein:
said first neural network is trained to determine said first function which maps the known sequences to the known values by:
dividing each polypeptide chain in said set of polypeptide chains into a plurality of segments, with each segment having a first fixed length;
inputting each segment into said first neural network by representing each amino acid in each segment using an input neuron in the first neural network; and
determining said first function from said input segments and said known values;
said second neural network is trained to determine said second function which maps the known sequences to the known values by:
dividing each polypeptide chain in said set of polypeptide chains into a plurality of segments each having a second fixed length; wherein said second length is greater than said first length;
inputting each segment into said second neural network by representing each amino acid in each segment using an input neuron in the second neural network; and
determining said second function from said input segments and said known values.

55. The system of claim 54, wherein the number of input neurons in the first neural network is 22 and the number of input neurons in the second neural network is 40, and wherein the solubility or aggregation propensity is in the form of a profile to which a Fourier transform has been applied and each of the first and second neural networks determines a function which generates a set of Fourier coefficients, wherein preferably a subset of the set of Fourier coefficients are used as the known values to reduce the number of output neurons in each of the first and second neural networks.

56. The system of claim 53,
wherein said first trained neural network is configured to generate said first output value of said solubility or aggregation propensity for each mutated sequence by:
dividing each mutated sequence into a plurality of segments each having a first fixed length,
inputting each amino acid in each segment to the first neural network;
using the first function to map the input amino acids to a first segment output value for each segment; and
combining the first segment output values to generate said first output value;
wherein said second trained neural network is configured to generate said second output value of said solubility or aggregation propensity for each mutated sequence by:
dividing said input polypeptide chain into a plurality of segments each having a said second length which is greater than said first length,
inputting each amino acid in each segment to the second neural network and
using the second function to map the input amino acids to a second segment output value for each segment; and
combining the second segment output values to generate said second output value.

57. The method of claim 49, further comprising making at least one of the output polypeptide chains.
